(19) United States
(12) Patent Application Publication
(10) Pub. No.: US 2026/0084447 A1
(43) Pub. Date: Mar. 26, 2026

(54) HANDLING APPARATUS, HANDLING UNIT, AND PRINTING SYSTEM

(71) Applicant: BROTHER KOGYO KABUSHIKI KAISHA, Nagoya (JP)

(72) Inventor: Kengo TAKEDA, Chita (JP)

(73) Assignee: BROTHER KOGYO KABUSHIKI KAISHA, Nagoya (JP)

(21) Appl. No.: 19/337,989

(22) Filed: Sep. 24, 2025

(30) Foreign Application Priority Data
Sep. 26, 2024 (JP) 2024-167531

(51) Int. Cl. B41J 13/10; B41J 3/407; B41J 11/06; B41J 11/14; B41J 13/08

(52) U.S. Cl. CPC B41J 13/103; B41J 3/4078; B41J 11/06; B41J 11/14; B41J 13/08

(57) ABSTRACT

A handling apparatus includes: a first electric cylinder movable between a first proximate position at which the first electric cylinder is proximate to a right edge of a platen and a first separated position at which the first electric cylinder is separated farther from the right edge than at the first proximate position; a first pushing bar fixed to the first electric cylinder and located in an under-platen space defined under the platen when the first electric cylinder is located at the first proximate position; and a controller. After a T-shirt is loaded on the platen, the controller executes: moving the first electric cylinder from the first separated position to the first proximate position, and bringing the first pushing bar into contact with a right sleeve of the T-shirt.

### REFERENCE TO RELATED APPLICATIONS

This application claims priority from Japanese Patent Application No. 2024-167531 filed on Sep. 26, 2024. The entire content of the priority application is incorporated herein by reference.

### BACKGROUND ART

For example, conventionally, an operator first inserts a placement stand into a T-shirt through the hem part, and positions the T-shirt so that a part, of the T-shirt, for which printing is to be performed is aligned with the inserted placement stand. Next, the operator tucks the sleeve, hem, and neck parts of the T-shirt which are extending beyond the placement stand into the inside of the placement stand, and presses the T-shirt with a pressing member. This prevents the parts, of the T-shirt, other than the part for which the printing is to be performed from coming into contact, for example, with a print head and being stained.

### SUMMARY

In the above technique, the operator manually performs an operation of tucking the sleeve, hem and neck parts of the T-shirt which extend beyond the placement stand into the inside of the placement stand. Therefore, the operator might sometimes forget to perform the operation of tucking the sleeve, hem, and neck parts of the T-shirt into the inside of the placement stand. In a case where the printing is performed on the T-shirt in a state that the T-shirt extends beyond the placement stand, ink mist generated from the head might adhere to a non-printing area of the T-shirt and stain the T-shirt. In such an assumed case that a robot arm is caused to automatically perform the operation of tucking the sleeve, hem, and neck parts of the T-shirt into the inside of the placement stand, the complicated movement of the robot arm might slow down the throughput of a controller and lower the productivity.

The present disclosure has been made in view of the above-described problem, and aims to provide a handling apparatus, a handling unit, and a printing system wherein even in a case where a part of a medium loaded on a platen extends outward beyond an under-platen space defined under the platen, as an extending area of the medium, each of the handling apparatus, the handling unit, and the printing system is capable of automatically and quickly pushing the extending area of the medium into the under-platen space defined under the platen.

An aspect of the present disclosure relates to a handling apparatus. The handling apparatus handles a medium having a tubular shape and loaded on a platen extending in a first direction and a second direction crossing the first direction, so that a first layer of the medium is located on an upper surface of the platen and a second layer of the medium is located in an under-platen space defined under the platen in a case where the medium is loaded on a platen. The handling apparatus includes: a first moving part movable in the second direction between a first proximate position at which the first moving part is proximate to a first edge of the platen extending in the first direction, and a first separated position at which the first moving part is separated farther from the first edge than at the first proximate position; a first contacting part which is fixed to the first moving part, the first contacting part being located in the under-platen space in a case where the first moving part is located at the first proximate position; and a controller. The controller is configured to execute a first pushing process of pushing a first extending area of the medium into the under-platen space, the first extending area being located between the first layer and the second layer of the medium and extending in the second direction outward beyond the first edge of the platen. In the first pushing process, the controller executes: causing the first moving part to move in the second direction from the first separated position to the first proximate position, after the medium has been loaded on the platen, and bringing the first contacting part into contact with the first extending area.

Even in a case where the first extending area, as a part of the medium loaded on the platen, extends in the second direction outward beyond the first edge of the platen, the first extending area is automatically pushed into the under-platen space by the first contacting part.

By simply moving the first moving part from the first separated position to the first proximate position in the second direction, the first extending area can be pushed into the under-platen space. Accordingly, the first extending area can be pushed into the under-platen space more quickly than in a case where a complex operation is performed by, for example, a robot arm.

According to the present disclosure, even in a case where an extending area, as a part of the medium loaded on the platen extends outward beyond the under-platen space, each of the handling apparatus, the handling unit, and the printing system is capable of automatically and quickly pushing the extending area of the medium into the under-platen space.

### BRIEF DESCRIPTION OF DRAWINGS

FIG. 1 is a plan view of a printing system 1.

FIG. 2 is a perspective view of a platen unit 24.

FIG. 3 is a side view of the platen unit 24.

FIG. 4 is a front view of the platen unit 24.

FIG. 5 is a cross-sectional view of the platen unit 24 with a T-shirt 100 loaded on a platen 38, taken along a plane orthogonal to the front-rear direction.

FIG. 6 is a plan view illustrating the positional relationship between the platen unit 24 and a right handling device 151.

FIG. 7 is a side view of the right handling device 151.

FIG. 8 illustrates a state that a first electric cylinder 71 is located at a first proximate position at which an end part 111 of a first rod 71B is proximate to a right edge 38A of the platen 38.

FIG. 9 illustrates a state that a second electric cylinder 73 is located at a second proximate position at which an end part 113 of a second rod 73B is proximate to the right edge 38A of the platen 38.

FIG. 10 is a plan view illustrating the positional relationship between the platen unit 24 and a left handling device 152.

FIG. 11 is a side view of the left handling device 152.

FIG. 12 illustrates a state that a third electric cylinder 81 is located at a third proximate position at which an end part 115 of a third rod 81B is proximate to a left edge 38B of the platen 38.

FIG. 13 illustrates a state that a fourth electric cylinder 83 is located at a fourth proximate position at which an end part 116 of a fourth rod 83B is proximate to the left edge 38B of the platen 38.

FIG. 14 is a plan view illustrating the positional relationship between the platen unit 24 and a front handling device 153.

FIG. 15 is a side view of the front handling device 153.

FIG. 16 illustrates a state that a fifth electric cylinder 91 is located at a fifth proximate position at which an end part 118 of a fifth rod 91B is proximate to a front edge 38C of the platen 38.

FIG. 17 illustrates a state that a sixth electric cylinder 93 is located at a sixth proximate position at which an end part 129 of a sixth rod 93B is proximate to the front edge 38C of the platen 38.

FIG. 18 is a functional block diagram of the printing system 1.

FIGS. 19A and 19B depict a flowchart indicating a print controlling process.

FIG. 20 schematically illustrates a right sleeve 100C, a left sleeve 100D, and a collar 100E of the T-shirt 100.

FIG. 21 illustrates a state that a first pushing bar 72 pushes an upper part of the right sleeve 100C into an under-platen space 46 concurrently with a third pushing bar 82 pushing an upper part of the left sleeve 100D into the under-platen space 46.

FIG. 22 illustrates a state that a second pushing bar 74 pushes a lower part of the right sleeve 100C into the under-platen space 46, concurrently with a fourth pushing bar 84 pushing a lower part of the left sleeve 100D into the under-platen space 46.

FIG. 23 illustrates a state that a fifth pushing bar 92 pushes an upper part of the collar 100E into the under-platen space 46.

FIG. 24 illustrates a state that a sixth pushing bar 94 pushes a lower part of the collar 100E rearward and into the under-platen space 46.

FIG. 25 is a plan view of a printing system 1 according to a modification.

### DESCRIPTION

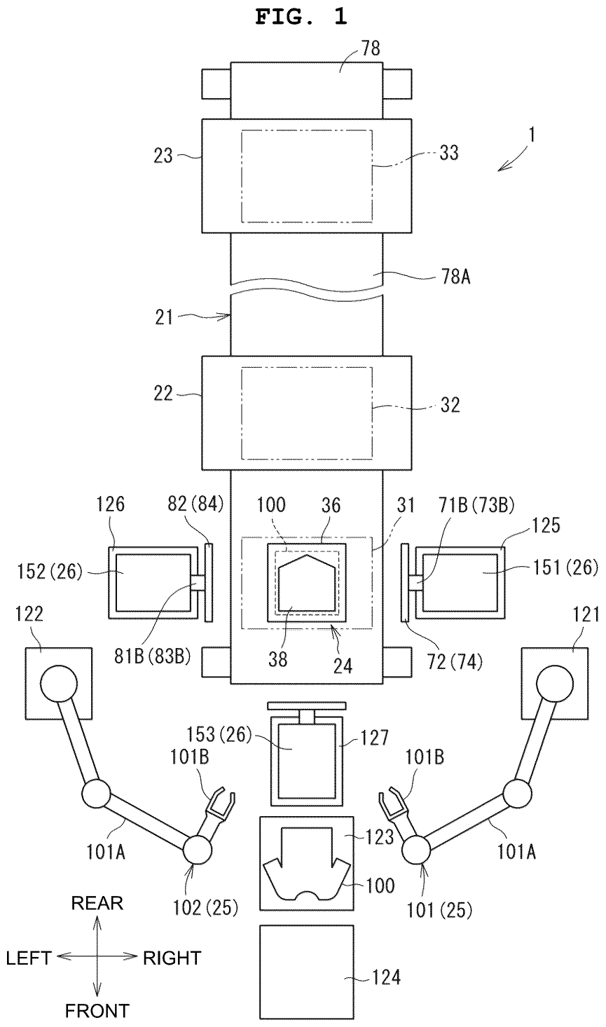

An embodiment of the present disclosure will be described as follows, with reference to the drawings as appropriate. Note that the embodiment to be described below is merely an example of the present disclosure. Needless to say that the embodiment of the present disclosure may be changed as appropriate within the range not changing the gist of the present disclosure. In the following description, the left-right direction, front-rear direction, and up-down direction each of which is indicated by an arrow in FIG. 1 are used. The left-right direction, the front-rear direction, and the up-down directions are orthogonal to one another.

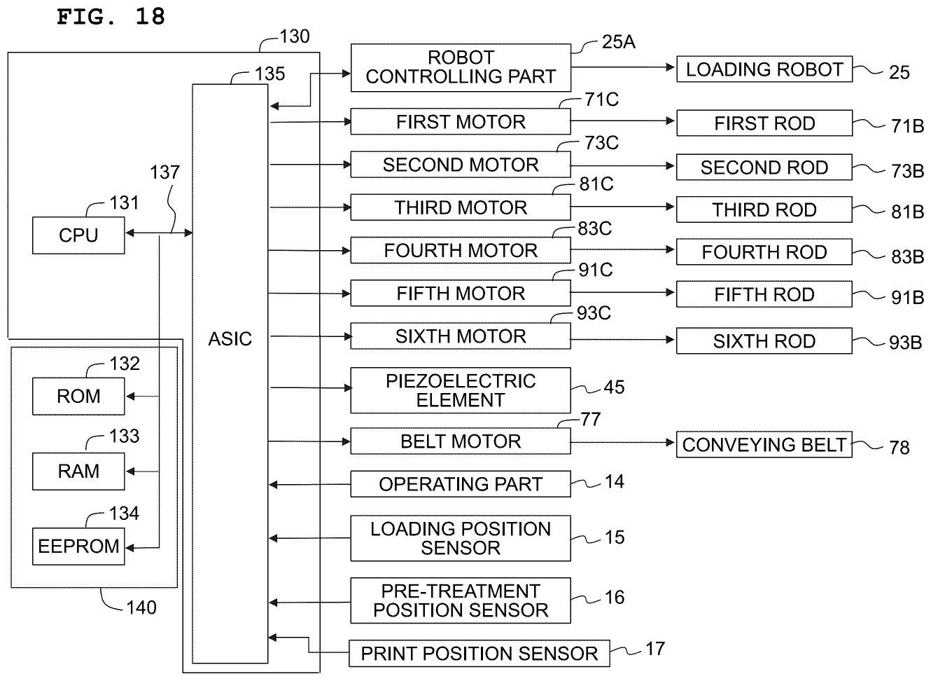

As depicted in FIG. 1, the printing system 1 is a system capable of sequentially performing a pre-treatment process and a printing process with respect to a medium having a tubular shape, while conveying a platen unit 24 having a platen 38 on which the medium is loaded. The medium having the tubular shape is, for example, a garment. In the present embodiment, a T-shirt 100 is used as the garment. The printing system 1 includes a platen moving part 21, a pre-treatment device 22, an ink-jet printer 23, the platen unit 24, a loading robot 25, a handling apparatus 26, and a controller 130 (see FIG. 18).

The platen moving part 21 conveys the platen unit 24 to a medium loading position 31, a pre-treatment position 32, and a print position 33 in this order. The platen moving part 21 returns the platen unit 24 from the print position 33, the pre-treatment position 32, and the medium loading position 31 in this order. The medium loading position 31 is a position at which the T-shirt 100 is loaded on the platen 38. The pre-treatment position 32 is a position at which the pre-treatment process is performed on the T-shirt 100 loaded on the platen 38. The print position 33 is a position at which printing is performed on the T-shirt 100 loaded on the platen 38. The platen moving part 21 has a conveying belt 78 and a belt motor 77 (see FIG. 18).

The conveying belt 78 is an annular belt extending in the front-rear direction. The conveying belt 78 is stretched by a driving pulley and a driven pulley which are spaced from each other in the front-rear direction. The conveying belt 78 has a placement surface 78A extending in the front-rear and left-right directions. The medium loading position 31 is located at a front end part of the placement surface 78A. The pre-treatment position 32 is located behind the pre-treatment position 32 on the placement surface 78A, and the print position 33 is located behind the pre-treatment position 32 on the placement surface 78A. The conveying belt 78 conveys the platen unit 24 in the front-rear direction in a state that the platen unit 24 is placed on the placement surface 78A. The belt motor 77 drives the driving pulley to thereby move the conveying belt 78 in the front-rear direction. In a case where the belt motor 77 rotates in the normal direction, the conveying belt 78 conveys the platen 38 rearward; in a case where the belt motor 77 rotates in the reverse direction, the conveying belt 78 conveys the platen 38 forward.

The pre-treatment device 22 is located at a position overlapping the pre-treatment position 32 in the front-rear direction. The pretreatment device 22 executes the pre-treatment on the T-shirt 100 loaded on the platen 38 located at the pre-treatment position 32. The pre-treatment device 22 includes, for example, a coating part and a heat treatment part. The coating part jets a pre-treatment agent with a spray and applies the pre-treatment agent to the T-shirt 100 loaded on the platen 38. The pre-treatment agent is a base coat agent applied to the T-shirt 100 before the ink is applied to the T-shirt 100. The pre-treatment agent is a liquid which forms a film between the fibers of the T-shirt 100 so that the ink stays in the T-shirt 100 longer, and includes, for example, a resin component. Further, the pre-treatment agent contains a divalent metal salt (such as CaCl₂ or Ca(NO₂)₂), as an example, to brighten the color development of the ink.

The ink-jet printer 23 is located at a position overlapping the print position 33 in the front-rear direction. The conveying belt 78 extends in the front-rear direction in the internal space of the ink-jet printer 23. The ink-jet printer 23 includes an ink-jet head 35 having a plurality of nozzles from which the ink is ejected. In a case where a piezoelectric element 45 (see FIG. 18) corresponding to each of the plurality of nozzles is driven, an ink droplet of the ink is ejected from each of the plurality of nozzles. The ink-jet printer 23 executes the printing on the T-shirt 100 loaded on the platen 38 located at the print position 33 by ejecting the ink from the plurality of nozzles.

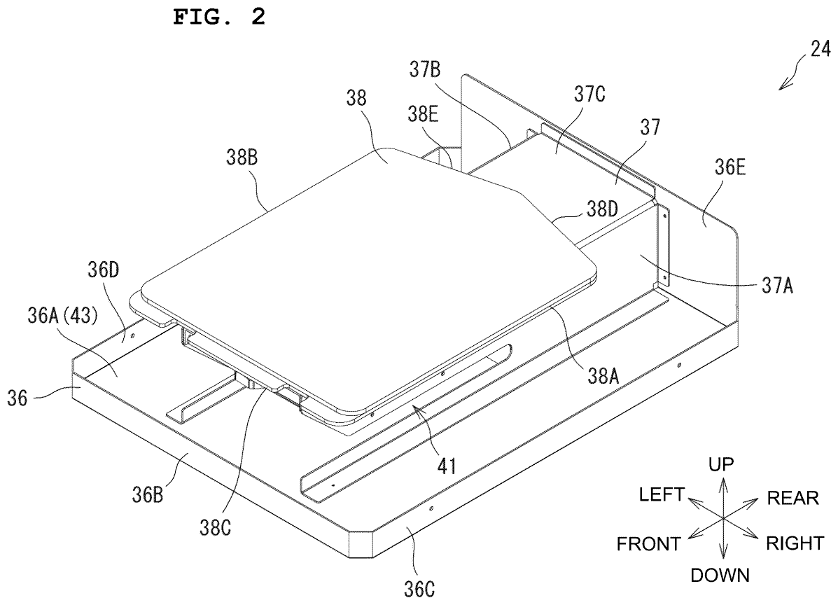

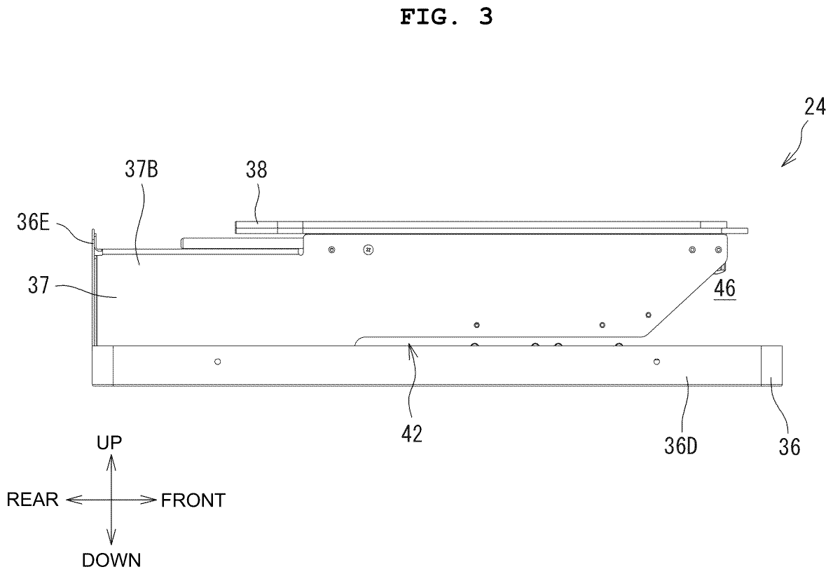

The platen unit 24 is located at the medium loading position 31 (see FIG. 1) in the placement surface 78A of the conveying belt 78. As depicted in FIGS. 2 and 3, the platen unit 24 has a base 36, a support stand 37, and the platen 38. The base 36 is placed at the medium loading position 31 (see FIG. 1) in the placement surface 78A of the conveying belt 78. The base 36 substantially has a shape of a tray. Specifically, the base 36 has a bottom plate 36A, a front plate 36B, a right plate 36C, a left plate 36D, and a rear plate 36E.

The bottom plate 36A has a shape of a flat plate extending in the front-rear direction and the left-right direction. The bottom plate 36A has a rectangular shape which is longer in the front-rear direction than in the left-right direction as viewed from above. The front plate 36B extends upward from the front end of the bottom plate 36A. The front plate 36B has a shape of a flat plate extending in the up-down direction and the left-right direction from the left end up to the right end of the bottom plate 36A. The right plate 36C extends upward from the right end of the bottom plate 36A. The right plate 36C has a shape of a flat plate extending in the front-rear direction and the up-down direction. The right plate 36C extends in the front-rear direction from the right end up to the rear end of the bottom plate 36A. The left plate 36D extends upward from the left end of the bottom plate 36A. The left plate 36D has a shape of a flat plate extending in the front-rear direction and the up-down direction. The left plate 36D extends in the front-rear direction from the front end up to the rear end of the bottom plate 36A. The rear plate 36E extends upward from the rear end of the bottom plate 36A. The rear plate 36E has a shape of a flat plate extending in the up-down direction and the left-right direction. The rear plate 36E extends up to a location above the front plate 36B, the left plate 36D, and the right plate 36C in the up-down direction. The rear plate 36E extends in the left-right direction from the left end up to the right end of the bottom plate 36A.

The support stand 37 is located on the upper surface of the bottom plate 36A. The support stand 37 has a substantially U-shape. Specifically, the support stand 37 has a right wall 37A, a left wall 37B, and an upper wall 37C.

The right wall 37A extends upward from a position which is to the right of the center in the left-right direction in the upper surface of the bottom plate 36A. The right wall 37A substantially has a shape of a flat plate extending in the front-rear direction and the up-down direction. The right wall 37A extends from a position slightly behind the front end in the upper surface of the bottom plate 36A to the rear end of the upper surface of the bottom plate 36A.

The right wall 37A is fixed to the upper surface of the bottom plate 36A and the front surface of the rear plate 36E. The front end of the right wall 37A is inclined rearward, with respect to the up-down direction, as the front end extends downward. A lower end part of the front end of the right wall 37A is partially cut so that a right cutout 41 extending rearward from the lower end part of the front end of the right wall 37A is defined. The right cutout 41 extends through the right wall 37A in the left-right direction.

The left wall 37B is bilaterally symmetrical with the right wall 37A. The left wall 37B extends upward from a position which is to the left of the center in the left-right direction in the upper surface of the bottom plate 36A. The left wall 37B substantially has a shape of a flat plate extending in the front-rear direction and the up-down direction. The left wall 37B extends from a position slightly behind the front end of the upper surface of the bottom plate 36A to the rear end of the upper surface of the bottom plate 36A. The left wall 37B is fixed to the upper surface of the bottom plate 36A and the front surface of the rear plate 36E. The front end of the left wall 37B is inclined, with respect to the up-down direction, rearward as the front end extends downward. A lower end part of the front end of the left wall 37B is partially cut so that a left cutout 42 extending rearward from the lower end part of the front end of the left wall 37B is defined. The left cutout 42 extends through the left wall 37B in the left-right direction.

The upper wall 37C connects the upper end of the right wall 37A and the upper end of the left wall 37B. The upper wall 37C has a shape of a flat plate extending in the front-rear direction and the left-right direction. The upper wall 37C extends in the front-rear direction from the front end to the rear end of each of the right wall 37A and the left wall 37B. The upper wall 37C is fixed to the front surface of the rear plate 36E.

The platen 38 is fixed to the upper surface of the upper wall 37C. The platen 38 has a shape of a flat plate extending in the front-rear direction and the left-right direction. The platen 38 has a pentagonal shape as viewed from above. A right edge 38A of the platen 38 extends in the front-rear direction. The entirety of the right edge 38A of the platen 38 is positioned to the right of the right surface of the right wall 37A. The right edge 38A is an example of a first edge. A left edge 38B of the platen 38 is located on the opposite side in the left-right direction with respect to the right edge 38A of the platen 38, and extends in the front-rear direction parallel to the right edge 38A. The entirety of the left edge 38B of the platen 38 is positioned to the left of the left surface of the left wall 37B. The left edge 38B is an example of a second edge. A front edge 38C of the platen 38 connects the right edge 38A and the left edge 38B. The front edge 38C of the platen 38 extends in the left-right direction. The entirety of the front edge 38C of the platen 38 is positioned in front of the front end of the upper wall 37C. The front edge 38C is an example of a third edge. The rear edge of the platen 38 has a right inclined edge 38D and a left inclined edge 38E. The right inclined edge 38D is inclined rearward with respect to the left-right direction as the right inclined edge 38E extends leftward from the rear end of the right edge 38A. The left end of the right inclined edge 38D is positioned at the center in the left-right direction of the platen 38. The left inclined edge 38E is inclined rearward with respect to the left-right direction as the left inclined edge 38E extends rightward from the rear end of the left edge 38B. The right end of the left inclined edge 38E is connected to the left end of the right inclined edge 38D. The front-rear direction is an example of a first direction. The left-right direction is an example of a second direction.

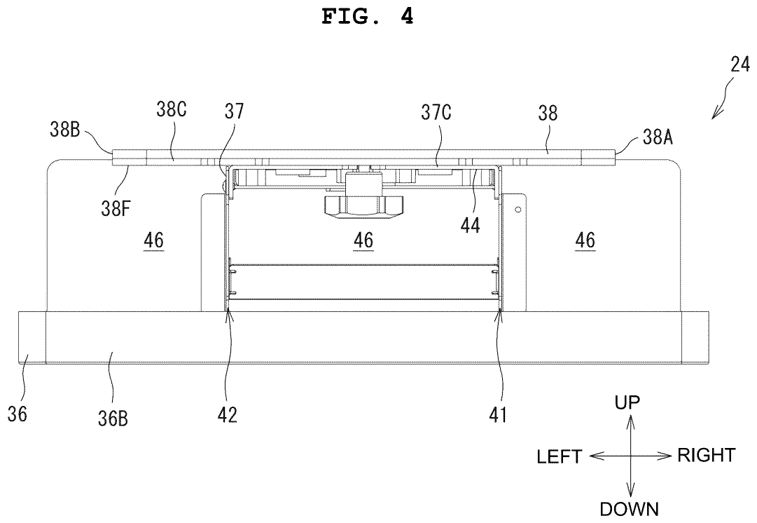

As depicted in FIGS. 3 and 4, an under-platen space 46 is defined under the platen 38. The under-platen space 46 is defined between the lower surface 38F of the platen 38 and an upper surface 43 of the bottom plate 36A (see FIG. 2). The lower end of the under-platen space 46 is defined by the upper surface 43 of the bottom plate 36A. The upper end of the under-platen space 46 is defined by a lower surface 44 of the upper wall 37C and the lower surface 38F of the platen 38. Specifically, the upper end of the under-platen space 46 is defined by a part at which the lower surface 44 of the upper wall 37C overlaps the platen 38 as viewed in the up-down direction, and a part at which the lower surface 38F of the platen 38 does not overlap the upper surface 37C as viewed in the up-down direction. The right end of the under-platen space 46 is continuous with a space defined to the right of the right edge 38A of the platen 38. The left end of the under-platen space 46 is continuous with a space defined to the left of the left edge 38B of the platen 38. The front end of the under-platen space 46 is continuous with a space defined in front of the front edge 38C of the platen 38. The rear end of the under-platen space 46 is continuous with a space defined behind the rear edge of the platen 38.

As depicted in FIG. 1, the loading robot 25 is spaced apart from the conveying belt 78 in the left-right direction. The loading robot 25 is located at a position overlapping the front end of the conveying belt 78 in the front-rear direction. The loading robot 25 is configured to be capable of loading the T-shirt 100 on the platen 38 located at the medium loading position 31.

The loading robot 25 is configured to be capable of unloading, from the platen 38, the T-shirt 100 loaded on the platen 38.

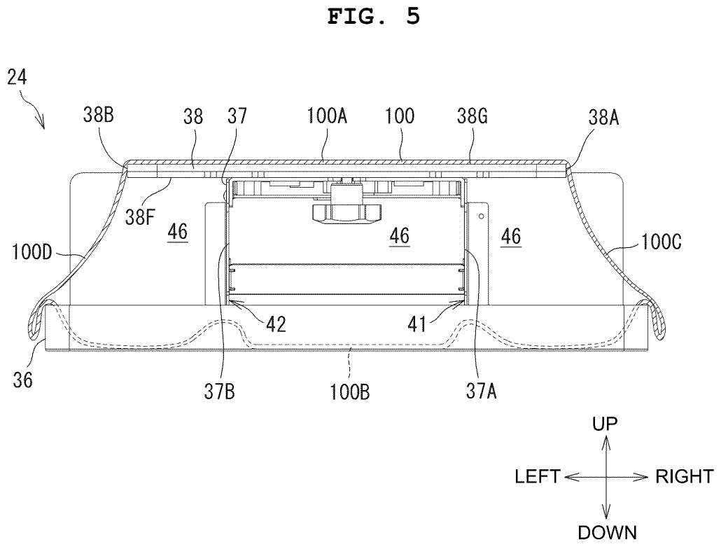

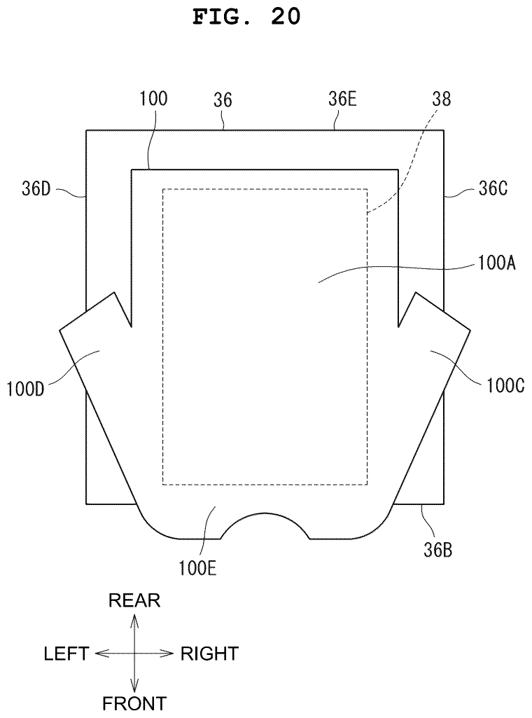

The T-shirt 100 has a front body panel 100A, a back body panel 100B, a collar 100E, a right sleeve 100C, and a left sleeve 100D (see FIGS. 5 and 20). The front body panel 100A is located on the front surface of the T-shirt 100; the back body panel 100B is located on the rear surface of the T-shirt 100; the collar 100E is the neckline and shoulder parts of the T-shirt 100.

The right sleeve 100C is located to the right of the collar 100E and between the front body panel 100A and the back body panel 100B. The left sleeve 100D is located to the left of the collar 100E and between the front body panel 100A and the back body panel 100B.

The loading robot 25 has a right robot arm 101 and a left robot arm 102. The right robot arm 101 is fixed to a right arm placement stand 121 which is spaced apart to the right from the conveying belt 78. The right arm placement stand 121 is disposed at a position overlapping the front end of the conveying belt 78 in the front-rear direction. The right robot arm 101 has an arm 101A and a hand 101B. The arm 101A has a plurality of joints, a plurality of links each of which is pivotably attached to a corresponding one of the plurality of joints, and a plurality of motors each of which rotates a corresponding one of the plurality of links. The hand 101B is pivotally attached to an end of the arm 101A. The hand 101B has a grasping part constructed of two fingers, a motor configured to rotate the grasping part, and a motor configured to move the two fingers.

The left robot arm 102 is fixed to a left arm placement stand 122 which is spaced apart to the left from the conveying belt 78. The left arm placement stand 122 is located at a position overlapping the front end of the conveying belt 78 in the front-rear direction. The left robot arm 102 has the structure same as the structure of the right robot arm 101. Accordingly, an element of the left robot arm 102 which corresponds to a counterpart element of the right robot arm 101 is designated by the same reference numeral as the counterpart element of the right robot arm 101, and the description of such an element will be omitted.

The loading robot 25 has a robot controlling part 25A (see FIG. 18). The robot controlling part 25A causes the right robot arm 101 and the left robot arm 102 to operate based on a program configured to perform a loading operation of causing the right robot arm 101 and the left robot arm 102 to grasp the hem of the T-shirt 100 placed on a shelf 123, which is spaced apart in front of the conveying belt 78, and to load the T-shirt 100 on the platen 38. A plurality of T-shirts 100 in a stacked state are placed on the shelf 123.

Specifically, the loading robot 25 extends the arm 101A of the right robot arm 101 and the arm 101A of the left robot arm 102 toward the shelf 123, and causes the two hands 101B and 101B, respectively, of the right robot arm 101 and the left robot arm 102 to grasp the hem of an uppermost T-shirt 100, among the plurality of T-shirts placed on the shelf 123, and to convey the T-shirt 100 to the platen 38. The loading robot 25 then passes the hem of the T-shirt 100 from the front edge 38C and through the right cutout 41 and the left cutout 42 to thereby insert the platen 38 into the T-shirt 100. With this, as depicted in FIG. 5, the front body panel 100A of the T-shirt 100 is located on the upper surface 38G of the platen 38, and the back body panel 100B of the T-shirt 100 is located in the under-platen space 46 of the platen 38. The front body panel 100A is an example of a first layer, and the back body panel 100B is an example of a second layer.

The robot controlling part 25A causes the right robot arm 101 and the left robot arm 102 to operate based on a program configured to perform an unloading operation of unloading, from the platen 38, the T-shirt 100 loaded on the platen 38 and placing the T-shirt 100 in a basket 124 positioned in front of the shelf 123.

Specifically, the loading robot 25 extends the arm 101A of the right robot arm 101 and the arm 101A of the left robot arm 102 toward the neckline of the T-shirt 100 loaded on the platen 38, and causes the two hands 101B and 101B to grasp the neckline of the T-shirts 100. In this state, the loading robot 25 causes the two hands 101B and 101B to pull the T-shirt 100 forward from the platen 38. Then, the loading robot 25 causes the arm 101A of the right robot arm 101 and the arm 101A of the left robot arm 102 to extend up to a location above the basket 124, and causes the two hands 101B and 101B to open so as to place the T-shirt 100 in the basket 124. Note that the structure of the loading robot 25 is not particularly limited, as long as the loading robot 25 is capable of performing the loading operation and the unloading operation.

The handling apparatus 26 handles the T-shirt 100 loaded on the platen 38. The handling apparatus 26 is configured as a separate apparatus from the platen unit 24. The handling apparatus 26 and the platen unit 24 are example of a handling unit. Specifically, as depicted in FIG. 1, the handling apparatus 26 has a right handling device 151, a left handling device 152, and a front handling device 153. The right handling device 151 is spaced apart to the right from the conveying belt 78. The right handling device 151 is located at a position overlapping the medium loading position 31 in the front-rear direction. The right handling device 151 is fixed to the upper surface of the right handling placement stand 125 spaced apart to the right from the conveying belt 78. The right handling placement stand 125 is located at a position overlapping the medium loading position 31 in the front-rear direction.

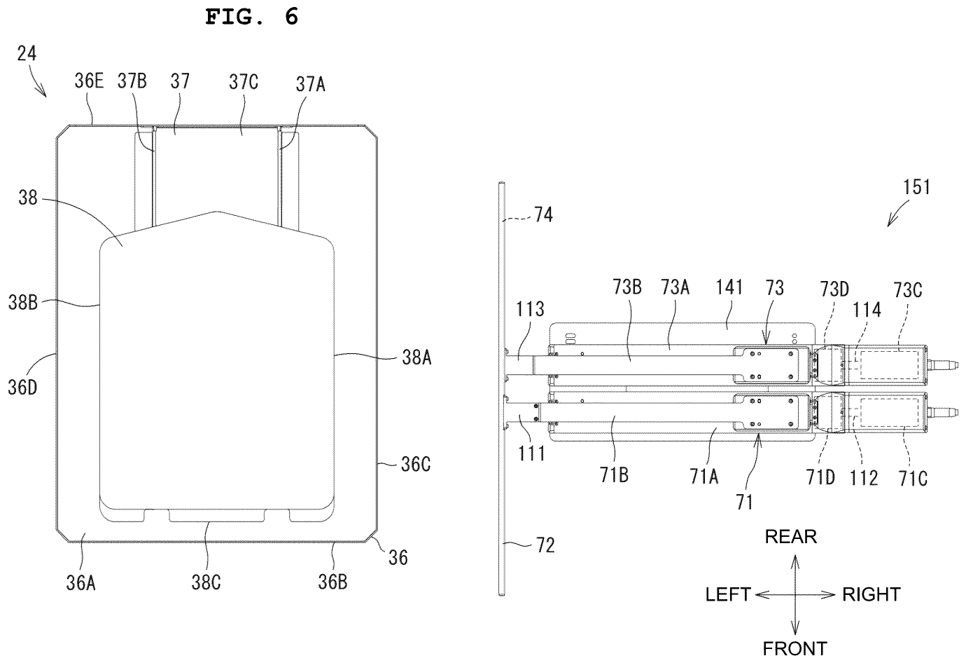

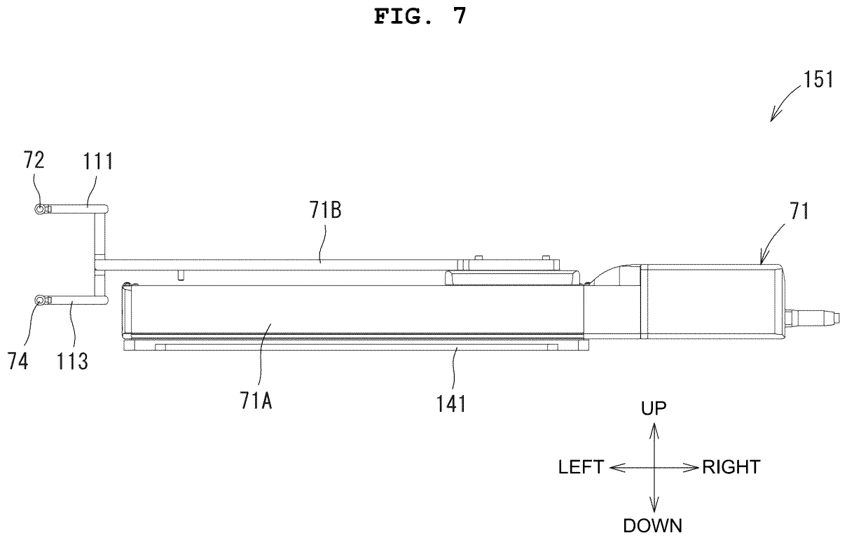

As depicted in FIGS. 6 and 7, the right handling device 151 has a first electric cylinder 71, a first pushing bar 72, a second electric cylinder 73, and a second pushing bar 74.

The first electric cylinder 71 has a first housing 71A, a first rod 71B, a first motor 71C, and a first converting mechanism 71D. The first electric cylinder 71 is an example of a first moving part.

The first housing 71A is fixed to the upper surface of a right support plate 141. The right support plate 141 has a shape of a flat plate extending in the front-rear direction and the left-right direction. The right support plate 141 is fixed to the upper surface of the right handling placement stand 125 (see FIG. 1). The first housing 71A has a rectangular parallelepiped shape which is long in the left-right direction. The first rod 71B is supported on the upper surface of the first housing 71A to be movable in the left-right direction. The first rod 71B substantially has a shape of a flat plate extending in the left-right direction and the front-rear direction. The first rod 71B is longer in the left-right direction than in the front-rear direction. An end part 111 of the first rod 71B is bent in a shape of a letter L to extend upward and then extend leftward.

The first motor 71C is located at a right end part in the inside of the first housing 71A.

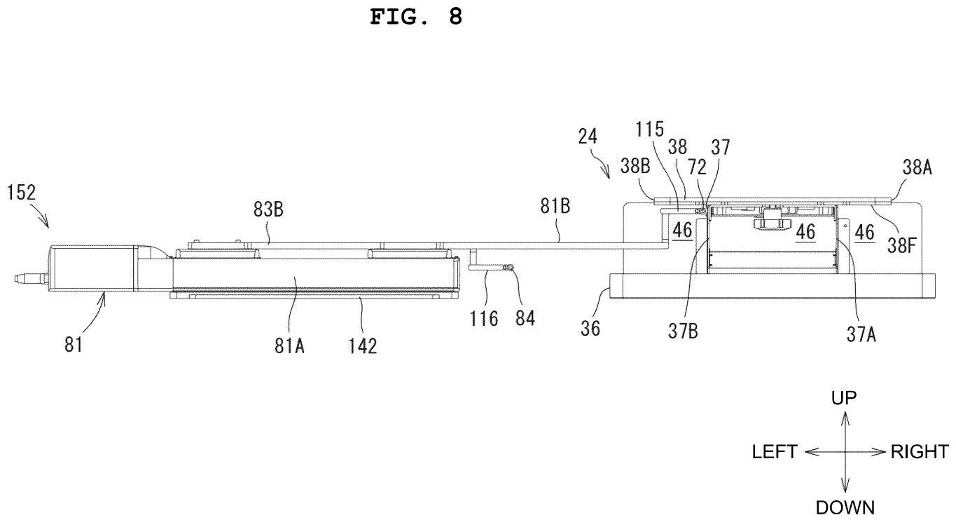

The first converting mechanism 71D is located to the left of the first motor 71C in the first housing 71A. The first converting mechanism 71D converts rotational motion of a first shaft 112 of the first motor 71C into linear motion of the first rod 71B in the left-right direction. The first conversion mechanism 71D causes the first rod 71B to move in the left-right direction between a first proximate position and a first separated position. As depicted in FIG. 8, the first proximate position is a position at which the end part 111 of the first rod 71B is proximate to the right edge 38A of the platen 38. In the present embodiment, the first proximate position is a position, in the under-platen space 46 of the platen 38, at which an end of the first rod 71B is slightly spaced rightward from the right wall 37A of the support stand 37, and at which the end of the first rod 71B is located proximate to the lower surface 38F of the platen 38. The first separated position is a position at which the end of the first rod 71B is separated farther rightward from the right edge 38A of platen 38 than at the first proximate position. In the present embodiment, as depicted in FIG. 6, the first separated position is a position at which the end of the first rod 71B is spaced apart to the right from the right plate 36C of the base 36.

The first pushing bar 72 is fixed to the end of the first rod 71B. The first pushing bar 72 has a shape of a bar extending parallel to the right edge 38A of the platen 38. The first pushing bar 72 has a cylindrical shape. The first pushing bar 72 is longer than the right edge 38A of the platen 38 in the front-rear direction. The front end of the first pushing bar 72 is located in front of the front end of the right edge 38A of the platen 38 in the front-rear direction. The rear end of the first pushing bar 72 is located behind the rear end of the right edge 38A of the platen 38 in the front-rear direction. At the first proximate position, the first pushing bar 72 is proximate to the right wall 37A of the support stand 37 in the under-platen space 46 of the platen 38, and the first pushing bar 72 is proximate to the lower surface 38F of the platen 38 in the under-platen space 46 (see FIG. 8). At the first separated position, the first pushing bar 72 is spaced apart to the right from the right plate 36C of the base 36. The first pushing bar 72 is an example of a first contacting part.

As depicted in FIGS. 6 and 7, the second electric cylinder 73 is fixed to the upper surface of the right support plate 141, at a position behind the first electric cylinder 71. The second electric cylinder 73 has a second housing 73A, a second rod 73B, a second motor 73C, and a second converting mechanism 73D. The second electric cylinder 73 is an example of a second moving part.

The second housing 73A is fixed to the upper surface of the right support plate 141. The second housing 73A has a shape of a rectangular parallelepiped which is long in the left-right direction. The second rod 73B is supported on the upper surface of the second housing 73A to be movable in the left-right direction. The second rod 73B substantially has a shape of a flat plate extending in the left-right direction and the front-rear direction. The second rod 73B is longer in the left-right direction than in the front-rear direction. An end part 113 of the second rod 73B is bent in a shape of letter L to extend downward and then extend leftward. An end of the second rod 73B is located below the end of the first rod 71B in the up-down direction. The second motor 73C is located at a right end part in the inside of the second housing 73A.

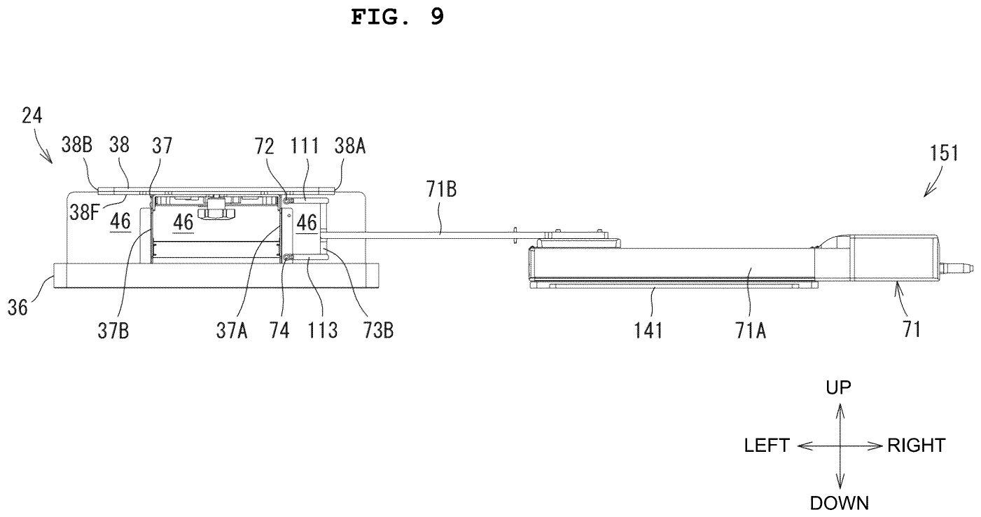

The second converting mechanism 73D is positioned to the left of the second motor 73C in the second housing 73A. The second converting mechanism 73D converts the rotational motion of a second shaft 114 of the second motor 73C into linear motion in the left-right direction of the second rod 73B. The second conversion mechanism 73D causes the second rod 73B to move in the left-right direction between a second proximate position and a second separated position. As depicted in FIG. 9, the second proximate position is a position at which the end part 113 of the second rod 73B is proximate to the right edge 38A of the platen 38. In the present embodiment, the second proximate position is a position at which an end of the second rod 73B is slightly spaced rightward from the right wall 37A of the support stand 37 in the under-platen space 46 of the platen 38, and at which the end of the second rod 73B is located below the center in the up-down direction in the under-platen space 46 of the platen 38. The second separated position is a position at which the end of the second rod 73B is separated rightward farther from the right edge of the platen 38 than at the second proximate position. In the present embodiment, the second separated position is a position at which the end of the second rod 73B is spaced apart to the right from the right plate 36C from the base 36 (see FIG. 6).

The second pushing bar 74 is fixed to the end of the second rod 73B. The second pushing bar 74 has a shape of a bar extending parallel to the right edge 38A of the platen 38.

The second pushing bar 74 has a cylindrical shape. The second pushing bar 74 is longer than the right edge 38A of the platen 38 in the front-rear direction. The front end of the second pushing bar 74 is located in front of the front end of the right edge 38A of the platen 38 in the front-rear direction. The rear end of the second pushing bar 74 is located behind the rear end of the right edge 38A of the platen 38 in the front-rear direction. At the second proximate position, the second pushing bar 74 is proximate to the right wall 37A of the platen 38 in the under-platen space 46 of the platen 38 and the second pushing bar 74 is located below the center in the up-down position in the under-platen space 46 of the platen 38. At the second separated position, the second pushing bar 74 is spaced apart to the right from the right plate 36C of the base 36 (see FIG. 6). The second pushing bar 74 is an example of a second contacting part.

As depicted in FIG. 1, the left handling device 152 is spaced apart to the left from the conveying belt 78. The left handling device 152 is disposed at a position overlapping with the medium loading position 31 in the front-rear direction. The left handling device 152 is fixed to the upper surface of a left handling placement stand 126 spaced apart to the left from the conveying belt 78. The left handling placement stand 126 is disposed at a position overlapping the medium loading position 31 in the front-rear direction.

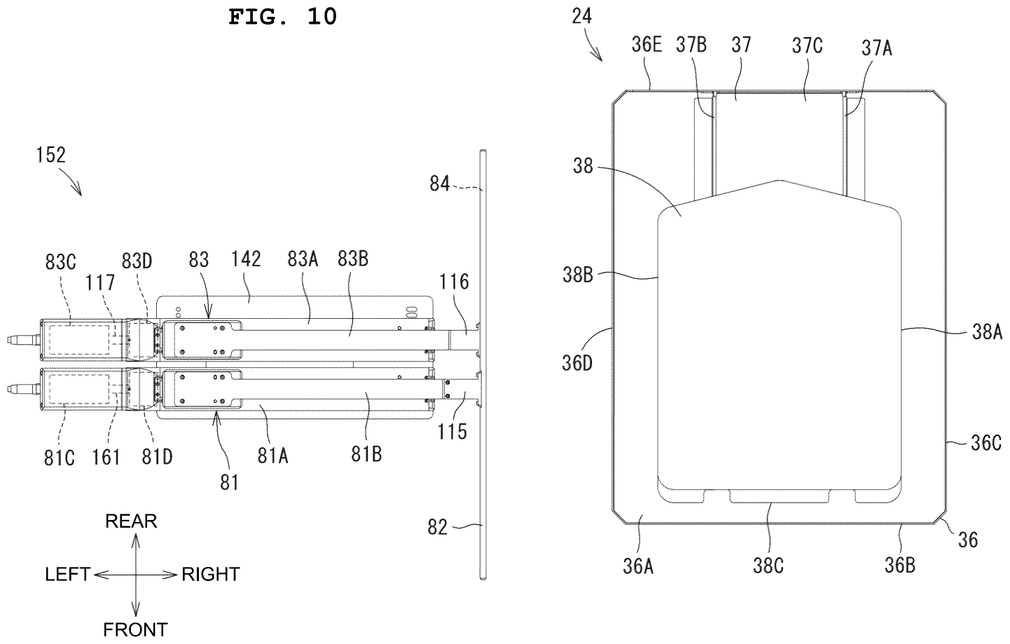

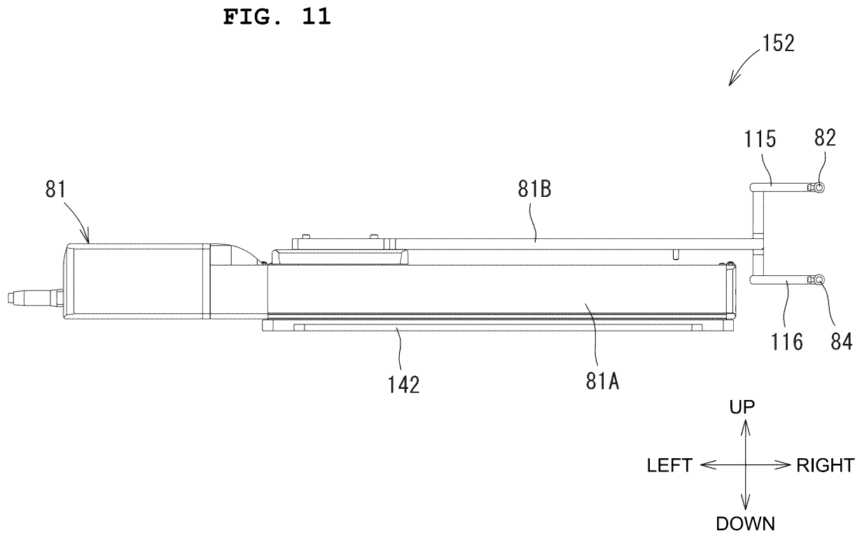

As depicted in FIGS. 10 and 11, the left handling device 152 has a third electric cylinder 81, a third pushing bar 82, a fourth electric cylinder 83, and a fourth pushing bar 84.

The third electric cylinder 81 has a third housing 81A, a third rod 81B, a third motor 81C, and a third converting mechanism 81D. The third cylinder 81 is an example of a third moving part.

The third housing 81A is fixed to the upper surface of a left support plate 142. The left support plate 142 has a shape of a flat plate extending in the front-rear direction and the left-right direction. The left support plate 142 is fixed to the upper surface of the left handling placement stand 126 (see FIG. 1). The third housing 81A has a rectangular parallelepiped shape which is long in the left-right direction. Third rod 81B is supported on the upper surface of third housing 81A to be movable in the left-right direction. The third rod 81B substantially has a shape of a flat plate extending in the left-right direction and the front-rear direction. The third rod 81B is longer in the left-right direction than in the front-rear direction. An end part 115 of the third rod 81B is bent in a shape of letter L to extend upward and then extend rightward. The third motor 81C is disposed at a left end part in the inside of the third housing 81A.

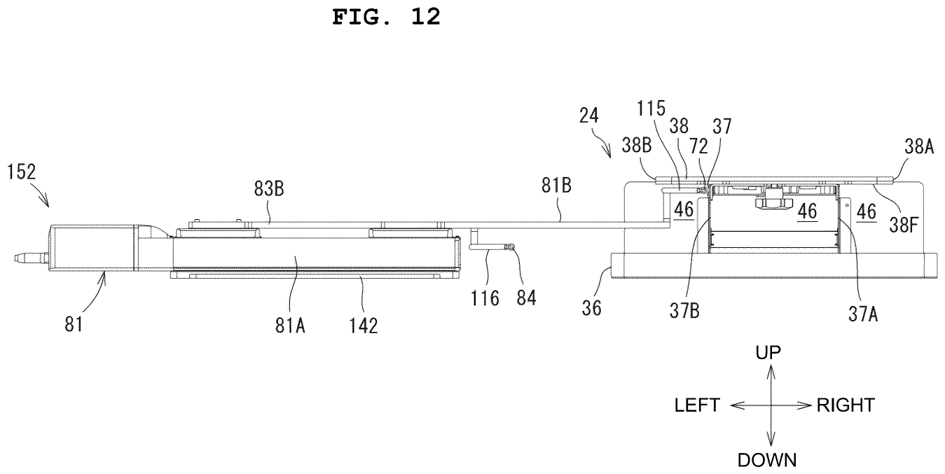

The third converting mechanism 81D is positioned to the right of the third motor 81C in the third housing 81A. The third converting mechanism 81D converts rotational motion of a third shaft 161 of the third motor 81C into linear motion of the third rod 81B in the left-right direction. The third conversion mechanism 80D causes the third rod 81B to move in the left-right direction between a third proximate position and a third separated position. The third proximate position is a position at which the end part 115 of the third rod 81B is proximate to the left edge 38B of the platen 38. In the present embodiment, as depicted in FIG. 12, the third proximate position is a position at which an end of the third rod 81B is slightly spaced leftward from the left wall 37B of the support stand 37 in the under-platen space 46 of the platen 38, and at which the end of the third rod 73B is located proximate to the lower surface 38F of the platen 38 in the under-platen space 46. The third separated position is a position at which the end of the third rod 81B is separated leftward farther from the left edge 38B of the platen than at the third proximate position. In the present embodiment, as depicted in FIG. 10, the third separated position is a position at which the end of the third rod 81B is spaced apart to the left from the left plate 36D of the base 36.

The third pushing bar 82 is fixed to the end of the third rod 81B. The third pushing bar 82 has a shape of a bar extending parallel to the left edge 38B of the platen 38. The third pushing bar 82 has a cylindrical shape. The third pushing bar 82 is longer than the left edge 38B of the platen 38 in the front-rear direction. The front end of the third pushing bar 82 is located in front of the front end of the left edge 38B of the platen 38 in the front-rear direction. The rear end of the third pushing bar 82 is located behind the rear end of the left edge 38B of the platen 38 in the front-rear direction. At the third proximate position, the third pushing bar 82 is proximate to the left wall 37B of the support stand 37 in the under-platen space 46 of the platen 38 and the third pushing bar 82 is proximate to the lower surface 38F of the platen 38 in the under-platen space 46 (see FIG. 12). At the third separated position, the third pushing bar 82 is spaced apart to the left from the left plate 36D of the base 36 (see FIG. 10). The third pushing bar 82 is an example of a third contacting part.

As depicted in FIGS. 10 and 11, the fourth electric cylinder 83 is fixed to the upper surface of the left support plate 142, at a position behind the third electric cylinder 81. The fourth electric cylinder 83 has a fourth housing 83A, a fourth rod 83B, a fourth motor 83C, and a fourth converting mechanism 83D. The fourth electric cylinder 83 is an example of a fourth moving part.

The fourth housing 83A is fixed to the upper surface of the left support plate 142.

The fourth housing 83A has a shape of a rectangular parallelepiped which is long in the left-right direction. The fourth rod 83B is supported on the upper surface of the fourth housing 83A to be movable in the left-right direction. The fourth rod 83B substantially has a shape of a flat plate extending in the left-right direction and the front-rear direction. The fourth rod 83B is longer in the left-right direction than in the front-rear direction. An end part 116 of the fourth rod 83B is bent in a shape of letter L to extend downward and then extend rightward. An end of the fourth rod 83B is positioned below the end of the third rod 81B in the up-down direction. The fourth motor 83 C is positioned at a left end part in the inside of the fourth housing 83A.

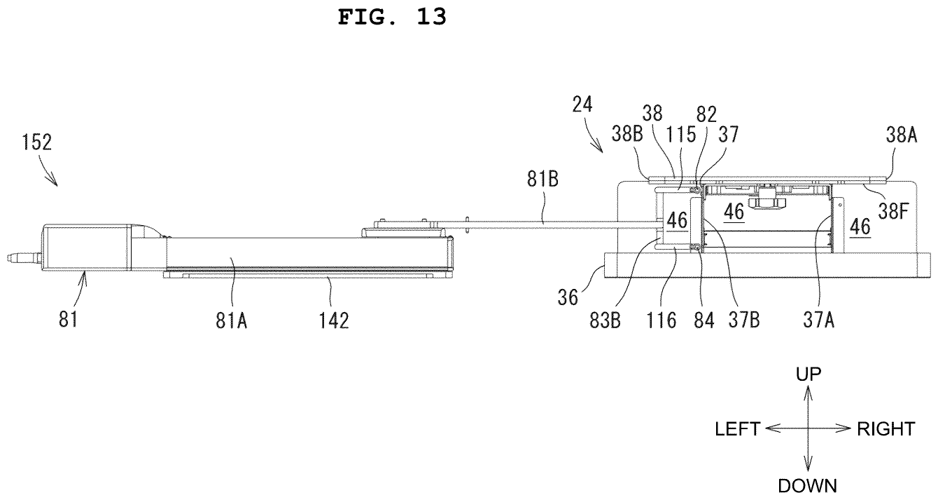

The fourth converting mechanism 83D is positioned to the right of the fourth motor 83C in the fourth housing 83A. The fourth converting mechanism 83D converts rotational motion of a fourth shaft 117 of the fourth motor 83C into linear motion of the fourth rod 83B in the left-right direction. The fourth converting mechanism 83D causes the fourth rod 83B to move in the left-right direction between a fourth proximate position and a fourth separated position. The fourth proximate position is a position at which the end part of the fourth rod 83B is proximate to the left edge 38B of the platen 38. In the present embodiment, as depicted in FIG. 13, the fourth proximate position is a position at which an end of the fourth rod 83B is slightly spaced leftward from the left wall 37B of the support stand 37 in the under-platen space 46 of the platen 38, and at which the end of the fourth rod 83B is located below the center in the up-down direction in the under-platen space 46 of the platen 38. The fourth separated position is a position at which the end of the fourth rod 83B is separated leftward farther from the left edge 38B of the platen 38 than at the fourth separated position. In the present embodiment, the fourth separated position is a position at which the end of the fourth rod 83B is spaced apart to the left from the left plate 36D of the base 36 (see FIG. 10).

The fourth pushing bar 84 is fixed to the end of the fourth rod 83B. The fourth pushing bar 84 has a shape of a bar extending parallel to the left edge 38B of the platen 38. The fourth pushing bar 84 has a cylindrical shape. The fourth pushing bar 84 is longer than the left edge 38B of the platen 38 in the front-rear direction. The front end of the fourth pushing bar 84 is located in front of the front end of the left edge 38B of the platen 38 in the front-rear direction. The rear end of the fourth pushing bar 84 is located behind the rear end of the left edge 38B of the platen 38 in the front-rear direction. At the fourth proximate position, the fourth pushing bar 84 is proximate to the left wall 37B in the under-platen space 46 of the platen 38, and the fourth pushing bar 84 is located below the center in the up-down direction in the under-platen space 46 of the platen 38 (see FIG. 13). At the fourth separated position, the fourth pushing bar 84 is spaced apart to the left from the left plate 36D of the base 36 (see FIG. 10). The fourth pushing bar 84 is an example of a fourth contacting part.

As depicted in FIG. 1, the front handling device 153 is spaced apart to the front from the conveying belt 78. The front handling device 153 is disposed at a position overlapping with the medium loading position 31 in the left-right direction. The front handling device 153 is fixed to a front handling placement stand 127 spaced apart to the front from the conveying belt 78.

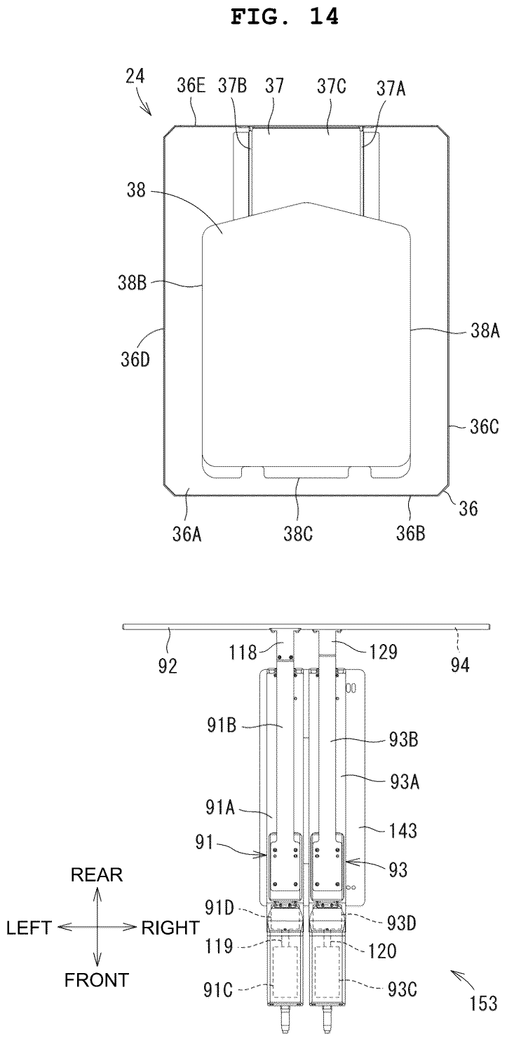

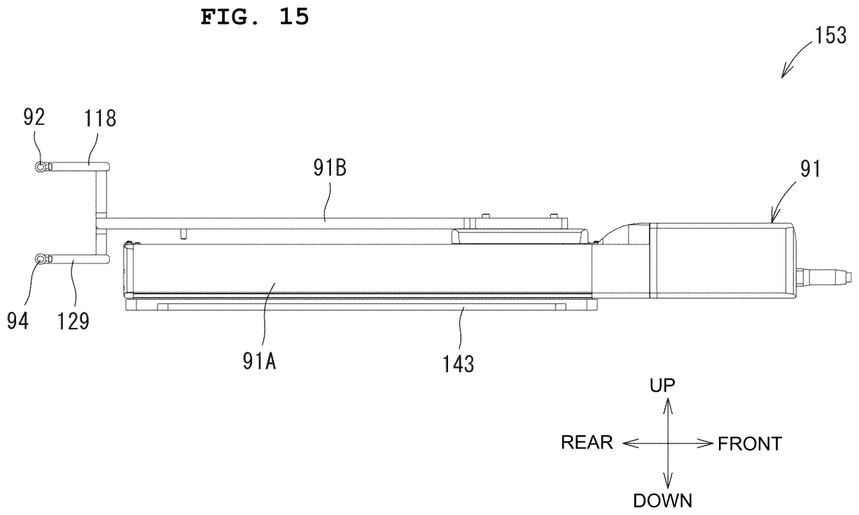

As depicted in FIGS. 14 and 15, the front handling device 153 has a fifth electric cylinder 91, a fifth pushing bar 92, a sixth electric cylinder 93, and a sixth pushing bar 94. The Fifth electric cylinder 91 has a fifth housing 91A, a fifth rod 91B, a fifth motor 91C, and a fifth converting mechanism 91D. The fifth cylinder 91 is an example of a fifth moving part.

The fifth housing 91A is fixed to the upper surface of a front support plate 143. The front support plate 143 has a shape of a flat plate extending in the front-rear direction and the left-right direction. The front support plate 143 is fixed to the upper surface of the front handling placement stand 127 (see FIG. 1). The fifth housing 91A has a shape of a rectangular parallelepiped which is long in the front-rear direction. The fifth rod 91B is supported on the upper surface of the fifth housing 91A to be movable in the front-rear direction. The fifth rod 91B substantially has a shape of a flat plate which extends in the left-right direction and the front-rear direction. The fifth rod 91B is longer in the front-rear direction than in the left-right direction. An end part 118 of the fifth rod 91B is bent in a shape of letter L to extend upward and then extend rearward. The fifth motor 91C is disposed at a front end part in the inside of the fifth housing 91A.

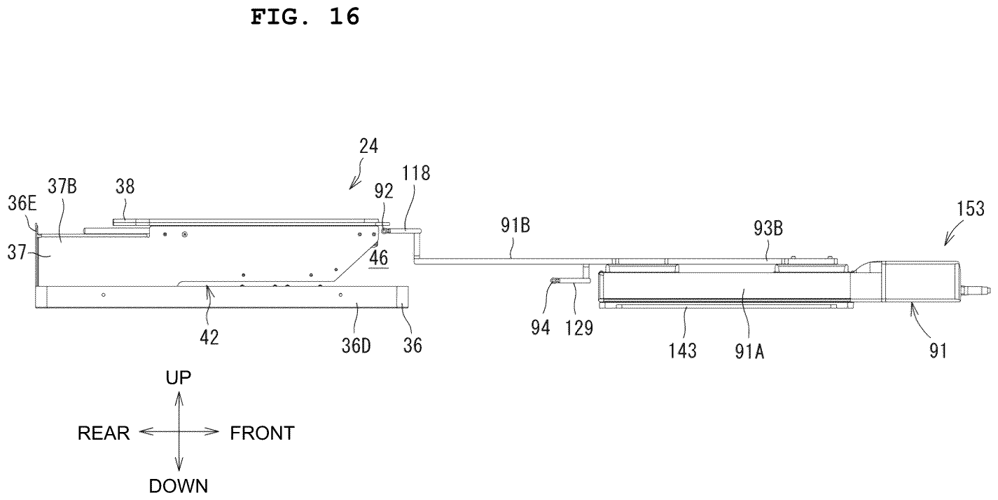

The fifth converting mechanism 91D is positioned behind the fifth motor 91C in the fifth housing 91A. The converting mechanism 91D converts rotational motion of a fifth shaft 119 of the fifth motor 91C into linear motion in the front-rear direction of the fifth rod 91B. The fifth converting mechanism 91D causes the fifth rod 91B to move in the front-rear direction between a fifth proximate position and a fifth separated position. The fifth proximate position is a position at which the end part 118 of the fifth rod 91B is proximate to the front edge 38C of the platen 38. In the present embodiment, as depicted in FIG. 16, the fifth proximate position is a position at which an end of the fifth rod 91B is slightly spaced forward from the front end of the left wall 37B and the front end of the right wall 37A of the support stand 37 in the under-platen space 46 of the platen 38, and at which the end of the fifth rod 91B is proximate to the lower surface 38F of the platen 38 in the under-platen space 46. The fifth separated position is a position at which the end of the fifth rod 91B is separated forward farther from the front edge 38C of the platen 38 than at the fifth proximate position. In the present embodiment, as depicted in FIG. 14, the fifth separated position is a position at which the end of the fifth rod 91B is spaced apart forward from the front plate 36B of the base 36.

The fifth pushing bar 92 is fixed to the end of the fifth rod 91B. The fifth pushing bar 92 has a shape of a bar extending parallel to the front edge 38C of the platen 38. The fifth pushing bar 92 has a cylindrical shape. The fifth pushing bar 92 is longer than the front edge 38C of the platen 38 in the left-right direction. The right end of the fifth pushing bar 92 is located to the right of the right end of the front edge 38C of the platen 38 in the left-right direction. The left end of the fifth pushing bar 92 is located to the left of the left end of the front edge 38C of the platen 38 in the left-right direction. At the fifth proximate position, the fifth pushing bar 92 is proximate to the front end of the right wall 37A and the front end of the left wall 37B of the support stand 37 in the under-platen space 46 of the platen 38, and the fifth pushing bar 92 is proximate to the lower surface 38F of the platen 38 in the under-platen space 46 (see FIG. 16). At the fifth separated position, the fifth pushing bar 92 is spaced apart to the front from the front plate 36B of the base 36 (see FIG. 14). The fifth pushing bar 92 is an example of a fifth contacting part.

As depicted in FIGS. 14 and 15, the sixth electric cylinder 93 is fixed to the upper surface of the front support plate 143 at a position to the right of the fifth electric cylinder 91. The sixth electric cylinder 93 has a sixth housing 93A, a sixth rod 93B, a sixth motor 93C, and a sixth converting mechanism 93D. The sixth electric cylinder 93 is an example of a sixth moving part.

The sixth housing 93A is fixed to the upper surface of the front support plate 143. The sixth housing 93A has a shape of a rectangular parallelepiped which is long in the front-rear direction. The sixth rod 93B is supported on the upper surface of the sixth housing 93A to be movable in the front-rear direction. The sixth rod 93B substantially has a shape of a flat plate extending in the left-right direction and the front-rear direction. The sixth rod 93B is longer in the front-rear direction than in the left-right direction. An end part 129 of the sixth rod 93B is bent in a shape of letter Lto extend downward and then extend rearward. An end of the sixth rod 93B is located below the end of the fifth rod 91B in the up-down direction. The sixth motor 93C is disposed at a front end part in the inside of the sixth housing 93A.

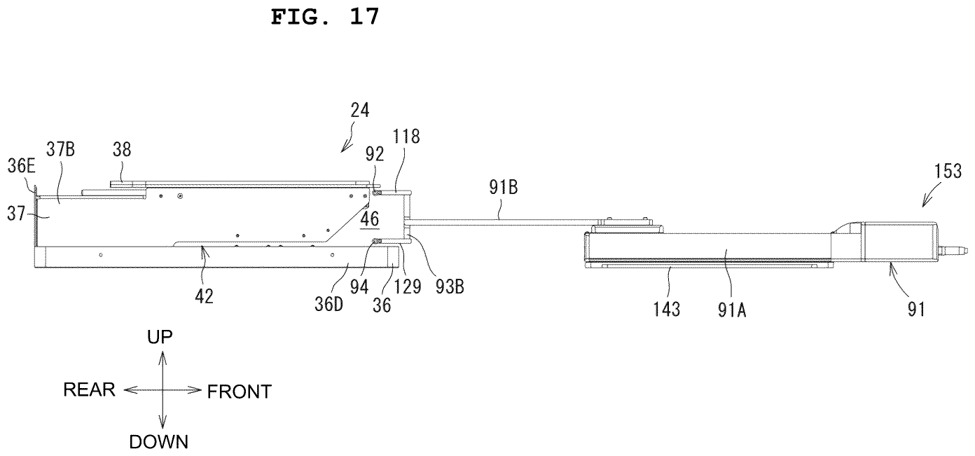

The sixth converting mechanism 93D is positioned behind the sixth motor 93C in the sixth housing 93A. The sixth converting mechanism 93D converts rotational motion of a sixth shaft 120 of the sixth motor 93C into linear motion in the front-rear direction of the sixth rod 93B. The sixth converting mechanism 93D causes the sixth rod 93B to move in the left-right direction between a sixth proximate position and a sixth separated position. The sixth proximate position is a position at which the end part 129 of the sixth rod 93B is proximate to the front edge 38C of the platen 38. In the present embodiment, as depicted in FIG. 17, the sixth proximate position is a position at which the end of the sixth rod 93B is located below the center of the up-down direction in the under-platen space 46 of the platen 38. The sixth separated position is a position at which the end of the sixth rod 93B is separated forward farther from the front edge 38C of the platen 38 than at the sixth proximate position. In the present embodiment, as depicted in FIG. 14, the sixth separated position is a position at which the end of the sixth rod 93B is located in front of the front plate 36B of the base 36.

The sixth pushing bar 94 is fixed to the end of the sixth rod 93B. The sixth pushing bar 94 has a shape of a bar extending parallel to the front edge 38C of the platen 38. The sixth pushing bar 94 has a cylindrical shape. The sixth pushing bar 94 is longer than the front edge 38C of the platen 38 in the left-right direction. The right end of the sixth pushing bar 94 is located to the right of the right end of the front edge 38C of the platen 38 in the left-right direction. The left end of the sixth pushing bar 94 is located to the left of the left end of the front edge 38C of the platen 38 in the left-right direction. As depicted in FIG. 17, at the sixth proximate position, the sixth pushing bar 94 is located below the center of the up-down direction in the under-platen space 46 of the platen 38. At the sixth separated position, the sixth pushing bar 94 is spaced apart forward from the front plate 36B of the base 36 (see FIG. 14). The sixth pushing bar 94 is an example of a sixth contacting part.

The controller 130 controls various operations of the printing system 1. As depicted in FIG. 18, the controller 130 includes a CPU 131 and an ASIC 135. A memory 140 has a ROM 132, a RAM 133, and an EEPROM 134. The CPU 131, the ASIC 135, the ROM 132, the RAM 133, and the EEPROM 134 are connected by an internal bus 137.

The ROM 132 stores, for example, a program which is to be used by the CPU 131 to control various operations. The RAM 133 is used as a memory area for temporarily storing data, a signal, etc., to be used by the CPU 131 in a case where the CPU 131 executes the above-described program, or as a work area for data processing. The EEPROM 134 stores setting, a flag, etc., to be retained even after the power of the printing system 1 is turned off.

An operating part 14 is connected to the ASIC 135. The operating part 14 receives various inputs by an operator. The operating part 14 transmits a start signal for starting printing to the ASIC 135. The operating part 14 transmits an end signal for ending the printing to the ASIC 135. A loading position sensor 15 is connected to the ASIC 135. In a case where the platen 38 is located at the medium loading position 31, the loading position sensor 15 transmits a detection signal to the ASIC 135. The robot controlling part 25A of the loading robot 25 is connected to the ASIC 135. The ASIC 135 transmits a loading signal to the robot controlling part 25A, thereby causing the loading robot 25 to execute the loading operation of loading the T-shirt 100 onto the platen 38. In a case where the loading operation is completed, the robot controlling part 25A transmits a loading completion signal to the ASIC 135. The ASIC 135 transmits an unloading signal to the robot controlling part 25A, thereby causing the loading robot 25 to execute the unloading operation of unloading the T-shirt 100 from the platen 38. In a case where the unloading operation is completed, the robot controlling part 25A transmits an unloading completion signal to the ASIC 135.

The first motor 71C, the second motor 73C, the third motor 81C, the fourth motor 83C, the fifth motor 91C, and the sixth motor 93C of the handling apparatus 26 are connected to the ASIC 135. The ASIC 135 controls the driving of each of the first motor 71C, the second motor 73C, the third motor 81C, the fourth motor 83C, the fifth motor 91C, and the sixth motor 93C. The belt motor 77 is connected to the ASIC 135. The ASIC 135 controls the driving of the belt motor 77.

A pre-treatment position sensor 16 is connected to the ASIC 135. The pre-treatment position sensor 16 transmits a detection signal to the ASIC 135 in a case where the platen 38 is located at the pre-treatment position 32. The pre-treatment device 22 is connected to the ASIC 135. The ASIC 135 causes the pre-treatment device 22 to execute the pre-treatment. A print position sensor 17 is connected to the ASIC 135. The print position sensor 17 transmits a detection signal to the ASIC 135 in a case where the platen 38 is located at the print position 33. The piezoelectric element 45 is connected to the ASIC 135. The ASIC 135 controls the power supply to the piezoelectric element 45 to thereby selectively eject an ink droplet from each of the plurality of nozzles.

### Print Controlling Process

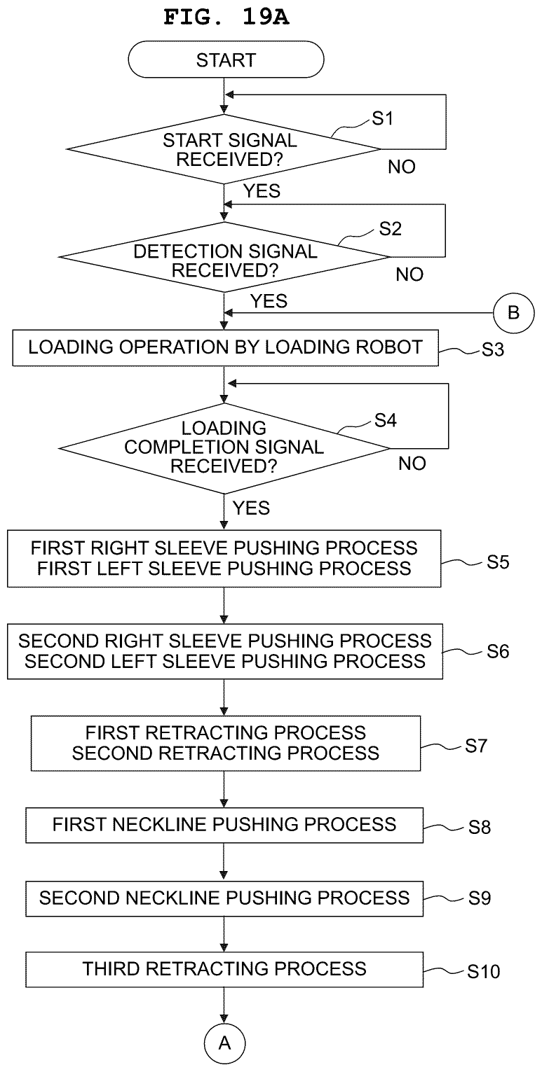

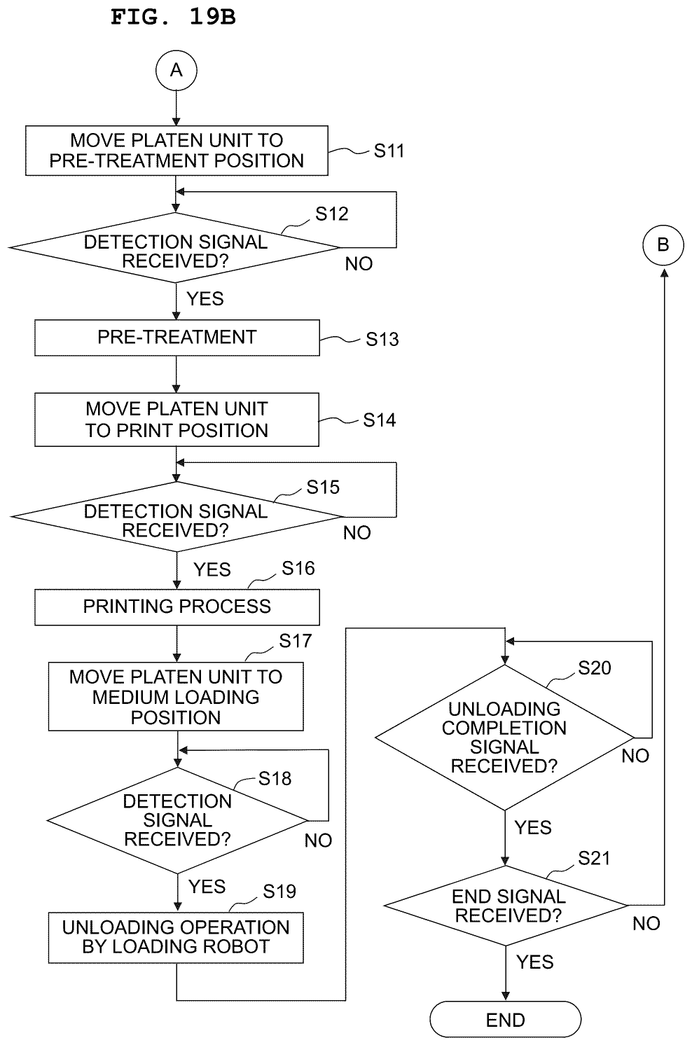

Next, a print controlling process by the controller 130 will be described, with reference to FIGS. 19A and 19B. As the initial state, the platen unit 24 is located at the medium loading position 31.

The controller 130 determines whether the start signal has been received from the operating part 14 (step S1). In a case where the controller 130 determines that the start signal has not been received from the operating part 14 (step S1: NO), the controller 130 stands by until the start signal is received from the operating part 14. In a case where the controller 130 determines that the start signal has been received from the operating part 14 (step S1: YES), the controller 130 determines whether the detection signal has been received from the loading position sensor 15 (step S2). In a case where the controller 130 determines that the detection signal has not been received from the loading position sensor 15 (step S2: NO), the controller 130 stands by until the detection signal is received from the loading position sensor 15. In a case where the controller 130 determines that the detection signal has been received from the loading position sensor 15 (step S2: YES), the controller 130 transmits the loading signal to the robot controlling part 25A, thereby causing the loading robot 25 to execute the loading operation (step S3). With this, the loading robot 25 executes the loading operation of grasping the T-shirt 100 placed on the shelf 123 and loading the T-shirt 100 on the platen 38.

As depicted in FIGS. 5 and 20, in a state that the loading operation is completed, the right sleeve 100C of the T-shirt 100 hangs down toward the upper surface 43 of the bottom plate 36A (see FIG. 2) while extending rightward beyond the right edge 38A of the platen 38. In a case where the T-shirt 100 is a large size, a portion, of the T-shirt 100, ranging from the right sleeve 100C to the hem part might extend rightward beyond the right edge 38A of the platen 38. In the present embodiment, the right sleeve 100C singly extends rightward beyond the right edge 38A of the platen 38, whereas the hem part does not extend rightward beyond the right edge 38A. The right sleeve 100C is an example of a first extending area. The right sleeve 100C is an example of a sleeve. The term “rightward” is an example of the term “outward”. Further, the left sleeve 100D of the T-shirt 100 is in a state that the left sleeve 100D hangs down toward the upper surface 43 of the bottom plate 36A (see FIG. 2) while extending leftward and beyond the left edge 38B of the platen 38. In the case where the T-shirt 100 is the large size, a portion, of the T-shirt 100, ranging from the left sleeve 100D to the hem part might extend leftward beyond the left edge 38B of the platen 38. In the present embodiment, the left sleeve 100D singly extends leftward beyond the left edge 38B of the platen 38, whereas the hem part does not extend leftward beyond the left edge 38B. The left sleeve 100D is an example of a second extending area. The term “leftward” is an example of the term “outward”. Furthermore, the collar 100E of the T-shirt 100 is in a state that the collar 100E hangs down toward the upper surface 43 of the bottom plate 36A (see FIG. 2), while extending forward beyond the front edge 38C of the platen 38. The collar 100E is an example of a third extending area. The term “forward” is an example of the term “outward”.

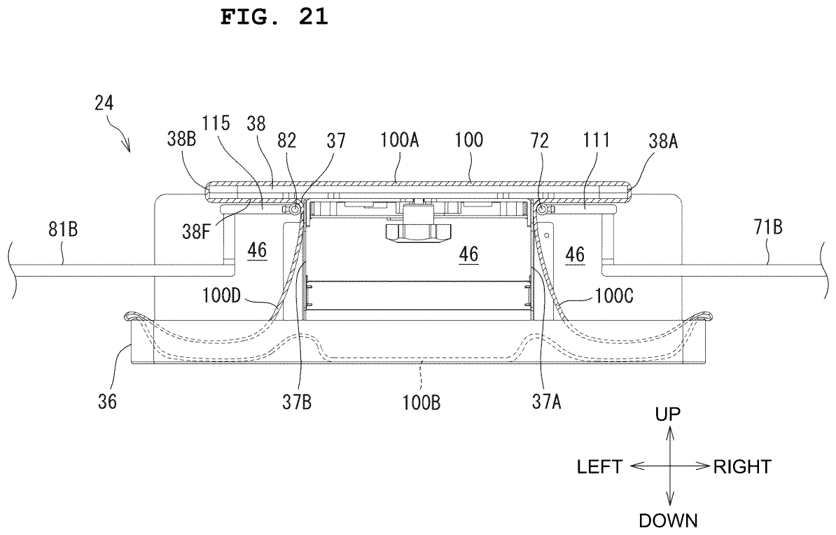

The controller 130 determines whether the loading completion signal has been received from the robot controlling part 25A (step S4). In a case where the controller 130 determines that the loading completion signal has not been received from the robot controlling part 25A (step S4: NO), the controller 130 stands by until the loading completion signal is received from the robot controlling part 25A. In a case where the controller 130 determines that the loading completion signal has been received from the robot controlling part 25A (step S4: YES), the controller 130 drives the first motor 71C by a previously set amount, thereby causing the right handling device 151 to execute a first right sleeve pushing process of moving the first rod 71B from the first separated position to the first proximate position (step S5). With this, as depicted in FIG. 21, the first pushing bar 72 is brought into contact with an upper part of the right sleeve 100C from the right, pushing the upper part of the right sleeve 100C leftward and into the under-platen space 46 of the platen 38. In this situation, a lower part of the right sleeve 100C also moves leftward and toward the under-platen space 46 of the platen 38, following the upper part of the right sleeve 100C. Note that in FIG. 21, only the T-shirt 100 is illustrated in cross section. The first right sleeve pushing process is an example of a first pushing process.

Concurrently with this, the controller 130 drives the third motor 81C by a previously set amount, thereby causing the left handling device 152 to execute a first left sleeve pushing process of moving the third rod 81B from the third separated position to the third proximate position (step S5). With this, the third pushing bar 82 is brought into contact with an upper part of the left sleeve 100D from the left, and pushes the upper part of the left sleeve 100D rightward and into the under-platen space 46 of the platen 38, as depicted in FIG. 21. In this situation, a lower part of the left sleeve 100D also moves rightward and toward the under-platen space 46 of the platen 38 following the upper part of the left sleeve 100D. The first left sleeve pushing process is an example of a third pushing process.

In this state, in a case where the T-shirt 100 is a small size, for example, in a case where the T-shirt 100 is size S, the T-shirt 100 is in such a state that the lower part of the right sleeve 100C and the lower part of the left sleeve 100D are also pushed into the under-platen space 46 of the platen 38. On the other hand, in a case where the T-shirt 100 is a large size, for example, in a case where the T-shirt 100 is size M or size L, the T-shirt 100 might be in such a state that the lower part of the right sleeve 100D and the lower part of the left sleeve 100D are not be fully pushed into the under-platen space 46 of the platen 38 and remain outside of the under-platen space 46 of the platen 38, as depicted in FIG. 21.

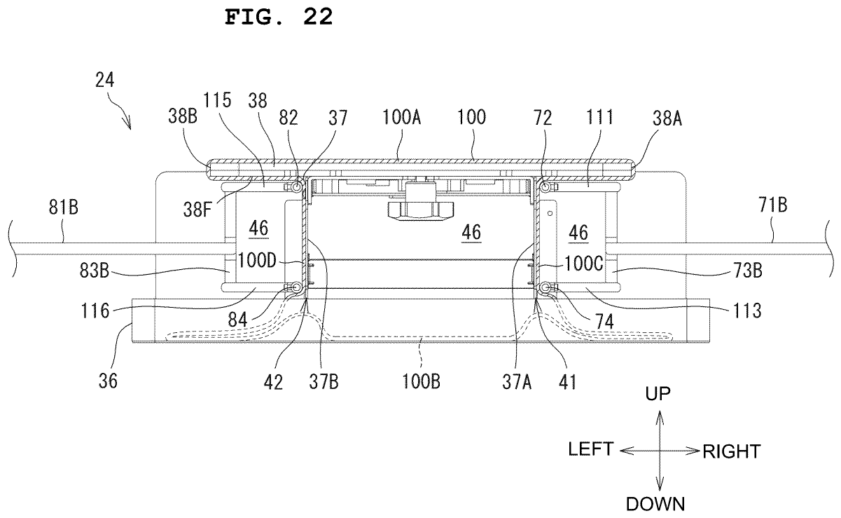

The controller 130 drives the second motor 73C by a previously set amount, thereby causing the right handling device 150 to execute a second right sleeve pushing process of moving the second rod 73B from the second separated position to the second proximate position (step S6). With this, the second pushing bar 74 is brought into contact with the lower part of the right sleeve 100C from the right, and pushes the lower part of the right sleeve 100C leftward and into the under-platen space 46 of the platen 38. With this, the entirety of the right sleeve 100C is pushed into the under-platen space 46 of the platen 38. Note that in FIG. 22, only the T-shirt 100 is illustrated in cross section. The second right sleeve pushing process is an example of a second pushing process. Concurrently with this, the controller 130 drives the fourth motor 83C by a previously set amount, thereby causing the left handling device 152 to execute a second left sleeve pushing process of moving the fourth rod 83B from the fourth separated position to the fourth proximate position (step S6). With this, the fourth pushing bar 84 is brought into contact with the lower part of the left sleeve 100D from the left, and pushes the lower part of the left sleeve 100D rightward and into the under-platen space 46 of the platen 38, as depicted in FIG. 22. With this, the entirety of the left sleeve 100D is pushed into the under-platen space 46 of the platen 38. The second left sleeve pushing process is an example of a fourth pushing process.

The controller 130 drives each of the first motor 71C and the second motor 73C by a previously set amount, thereby executing a first retracting process of moving the first rod 71B from the first proximate position to the first separated position and of moving also the second rod 73B from the second proximate position to the second separated position (step S7). Concurrently with this, the controller 130 drives each of the third motor 81C and the fourth motor 83C by a previously set amount, thereby executing a second retracting process of moving the third rod 81B from the third proximate position to the third separated position and of moving also the fourth rod 83B from the fourth proximate position to the fourth separated position (step S7).

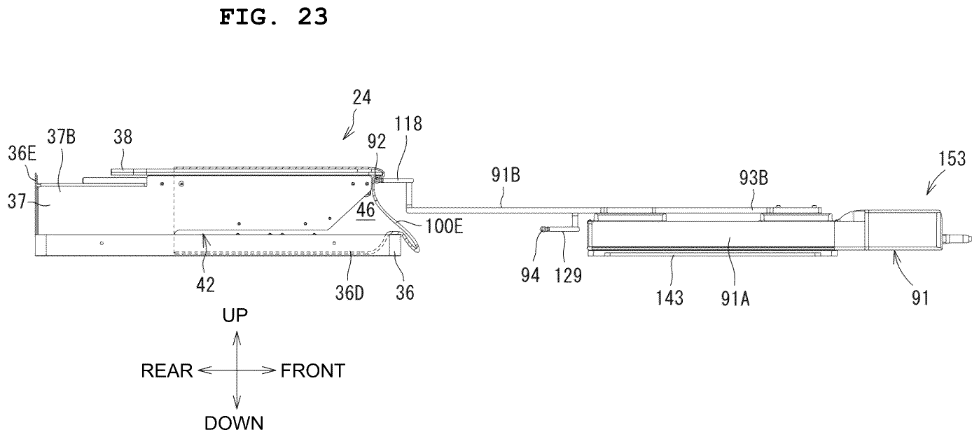

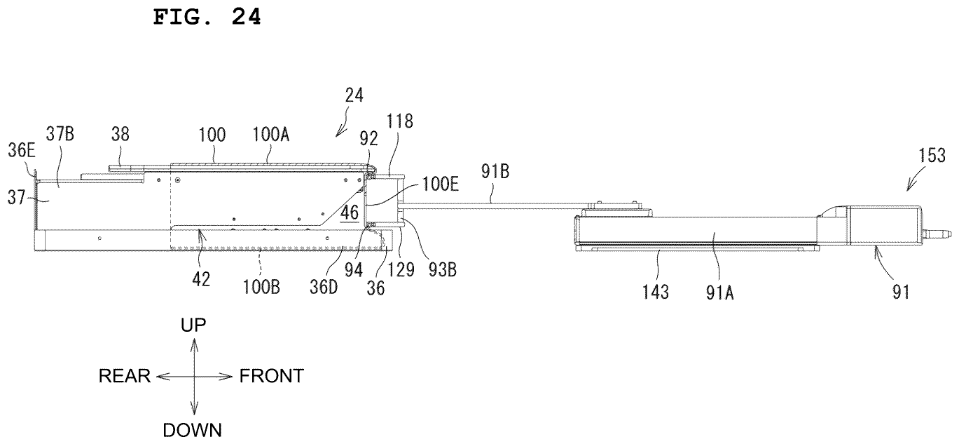

The controller 130 drives the fifth motor 91C by a previously set amount, thereby causing the front handling device 153 to execute a first neckline pushing process of moving the fifth rod 91B from the fifth separated position to the fifth proximate position (step S8). With this, the fifth pushing bar 92 is brought into contact with an upper part of the collar 100E from the front, and pushes the upper part of the collar 100E rearward and into the under-platen space 46 of the platen 38, as depicted in FIG. 23. The first neckline pushing process is an example of a fifth pushing process. The controller 130 drives the sixth motor 93C by a previously set amount, thereby causing the front handling device 153 to execute a second neckline pushing process of moving the sixth rod 93B from the sixth separated position to the sixth proximate position (step S9). With this, the sixth pushing bar 94 is brought into contact with a lower part of the collar 100E from the front, and pushes the lower part of the collar 100E rearward and into the under-platen space 46 of the platen 38, as depicted in FIG. 24. With this, the entirety of the collar 100E is pushed into the under-platen space 46 of the platen 38. The second neckline pushing process is an example of a sixth pushing process.

The controller 130 drives each of the fifth motor 91C and the sixth motor 93C by a previously set amount, thereby executing a third retracting process of moving the fifth rod 91B from the fifth proximate position to the fifth separated position and of moving also the sixth rod 93B from the sixth proximate position to the sixth separated position (step S10).

The controller 130 drives the belt motor 77 by a previously set amount, thereby executing a moving process of moving the platen unit 24 from the medium loading position 31 to the pre-treatment position 32 (step S11). The controller 130 determines whether the detection signal has been received from the pre-treatment position sensor 16 (step S12). In a case where the controller 130 determines that the detection signal has not been received from the pre-treatment position sensor 16 (step S12: NO), the controller 130 stands by until the detection signal is received from the pre-treatment position sensor 16. In a case where the controller 130 determines that the detection signal has been received from the pre-treatment position sensor 16 (step S12: YES), the controller 130 causes the pre-treatment device 22 to execute the pre-treatment (step S13). With this, the pre-treatment is executed on the front body panel 100A of the T-shirt 100 loaded on the platen 38.

The controller 130 drives the belt motor 77 by a previously set amount, thereby executing a moving process of moving the platen unit 24 from the pre-treatment position 32 to the print position 33 (step S14). The controller 130 determines whether the detection signal has been received from the print position sensor 17 (step S15). In a case where the controller 130 determines that the detection signal has not been received from the print position sensor 17 (step S15: NO), the controller 130 stands by until the detection signal is received from the print position sensor 17. In a case where controller 130 determines that the detection signal has been received from the print position sensor 17 (step S15: YES), the controller 130 controls the power supply to the piezoelectric element 45, thereby executing the printing process of selectively ejecting ink droplet from each of the plurality of nozzles (step S16). With this, printing is performed on the front body panel 100A of the T-shirt 100 loaded on the platen 38 located at the print position 33.

The controller 130 drives the belt motor 77 by a previously set amount, thereby moving the platen unit 24 from the print position 33 to the medium loading position 31 (step S17). The controller 130 determines whether the detection signal has been received from the loading position sensor 15 (step S18). In a case where the controller 130 determines that the detection signal has not been received from the loading position sensor 15 (step S18: NO), the controller 130 stands by until the detection signal is received from the loading position sensor 15. In a case where controller 130 determines that the detection signal has been received from the loading position sensor 15 (step S18: YES), the controller 130 transmits the unloading signal to the robot controlling part 25A, thereby causing the loading robot 25 to execute the unloading operation (step S19). With this, the loading robot 25 executes the unloading operation of unloading the T-shirt 100 from the platen 38 and placing the T-shirt 100 into the basket 124.

The controller 130 determines whether the unloading completion signal has been received from the robot controlling part 25A (step S20). In a case where controller 130 determines that the unloading completion signal has not been received from the robot controlling part 25A (step S20: NO), the controller 130 stands by until the unloading completion signal is received from the robot controlling part 25A. In a case where the controller 130 determines that the unloading completion signal has been received from the robot controlling part 25A (step S20: YES), the controller 130 determines whether the end signal has been received from the operating part 14 (step S21). In a case where the controller 130 determines that the end signal has not been received from the operating part 14 (step S21: NO), the controller 130 returns the process to step S3. In a case where controller 130 determines that the end signal has been received from the operating part 14 (step S21: YES), the controller 130 ends the print controlling process.

In the above-described embodiment, even in a case where the right sleeve 100C of the T-shirt 100 loaded on the platen 38 extends rightward beyond the right edge 38A of the platen 38, the right sleeve 100C extending rightward beyond the right edge 38A is automatically pushed into the under-platen space 46 of the platen 38 by the first pushing bar 72. By simply moving the pushing bar 71B of the first electric cylinder 71 leftward from the first separated position to the first proximate position, the right sleeve 100C can be pushed into the under-platen space 46 of the platen 38. Accordingly, the right sleeve 100C can be pushed into the under-platen space 46 of the platen 38 more quickly than in a case where the complex operation is performed by, for example, a robot arm.

In the above-described embodiment, after the upper part of the right sleeve 100C has been pushed into the under-platen space 46 of the platen 38 by the first pushing bar 72, the lower part of the right sleeve 100C is pushed into the under-platen space 46 of the platen 38 by the second pushing bar 74. Accordingly, the entirety of the right sleeve 100C can be easily pushed into the under-platen space 46 of the platen 38.

In the above-described embodiment, the first pushing bar 72 has the shape of the bar extending parallel to the right edge 38A of the platen 38. Accordingly, even in a case where the right sleeve 100C is long in the front-rear direction in which the right edge 38A of the platen 38 extends, the first pushing bar 72 is capable of pushing the right sleeve 100C into the under-platen space 46 of the platen 38.

In the above-described embodiment, the second pushing bar 74 has the shape of the bar extending parallel to the right edge 38A of the platen 38. Accordingly, even in a case where the right sleeve 100C is long in the front-rear direction in which the right edge 38A of the platen 38 extends, the second pushing bar 74 is capable of pushing the right sleeve 100C into the under-platen space 46 of the platen 38.

In the above-described embodiment, the length in the front-rear direction of each of the first pushing bar 72 and the second pushing bar 74 is longer than the length in the front-rear direction of the right edge 38A of the platen 38. Accordingly, even in such a case where the right sleeve 100C is wide in the front-rear direction in which the right edge 38A of the platen 38 extends, each of the first pushing bar 72 and the second pushing bar 74 is capable of easily pushing the right sleeve 100C into the under-platen space 46 of the platen 38.

In the above-described embodiment, the single first motor 71C causes the first rod 71B to move linearly in the left-right direction between the first separated position and the first proximate position, thereby causing the first pushing bar 72 to push the upper part of the right sleeve 100C into the under-platen space 46 of the platen 38. Accordingly, the first right sleeve pushing process can be executed more quickly than in a case where the right sleeve 100C is pushed into the under-platen space 46 of the platen 38 by a robot arm operated by a plurality of motors.

In the above-described embodiment, the single second motor 73C causes the second rod 73B to move linearly in the left-right direction between the second separated position and the second proximate position, thereby causing the second pushing bar 74 to push the lower part of the right sleeve 100C into the under-platen space 46 of the platen 38. Accordingly, the second right sleeve pushing process can be executed more quickly than in a case where the right sleeve 100C is pushed into the under-platen space 46 of the platen 38 by a robot arm operated by a plurality of motors.

In the above-described embodiment, even in a case where the right sleeve 100C of the T-shirt 100 loaded on the platen 38 extends rightward beyond the right edge 38A of the platen 38, the first pushing bar 72 is capable of pushing the right sleeve 100C into the under-platen space 46 of the platen 38.

In the above-described embodiment, the second pushing bar 74 is brought into contact with the lower part of the right sleeve 100C in the second right sleeve pushing process. Accordingly, the lower part of the right sleeve 100C can be pushed into the under-platen space 46 of the platen 38.

In the above-described embodiment, the first right sleeve pushing process of pushing the upper part of the right sleeve 100C into the under-platen space 46 of the platen 38, and the first left sleeve pushing process of pushing the upper part of the left sleeve 100D into the under-platen space 46 of the platen 38 are executed concurrently. Therefore, the right sleeve 100C and the left sleeve 100D are pushed into the under-platen space 46 of the platen 38 more quickly than in a case where the first right sleeve pushing process and the first left sleeve pushing process are executed separately.

In the above-described embodiment, after the upper part of left sleeve 100D is pushed into the under-platen space 46 of the platen 38 by the third pushing bar 82, the lower part of left sleeve 100D is pushed into the under-platen space 46 of the platen 38 by the fourth pushing bar 84. Accordingly, the entirety of the left sleeve 100D can be easily pushed into the under-platen space 46 of the platen 38.

In the above-described embodiment, the right sleeve 100C and the left sleeve 100D are pushed into the under-platen space 46 of the platen 38, and then the collar 100E is pushed into the under-platen space 46 of the platen 38. Accordingly, ink mist generated from the plurality of nozzles is less likely to adhere to the non-print area of the T-shirt 100 during the printing process.

In the above-described embodiment, after the upper part of the collar 100E is pushed into the under-platen space 46 of the platen 38 by the fifth pushing bar 92, the lower part of the collar 100E is pushed into the under-platen space 46 of the platen 38 by the sixth pushing bar 94. Accordingly, the entirety of the collar 100E can be easily pushed into the under-platen space 46 of the platen 38.

In the above-described embodiment, the fifth pushing bar 92 is brought into contact with the upper part of the collar 100E in the first neckline pushing process. Accordingly, even in a case where the collar 100E extends forward beyond the front edge 38C of the platen 38, the fifth pushing bar 92 is capable of pushing the upper part of the collar 100E into the under-platen space 46 of the platen 38.

In the above-described embodiment, the sixth pushing bar 94 is brought into contact with the lower part of the collar 100E in the second neckline pushing process. Accordingly, the lower part of the collar 100E can be pushed into the under-platen space 46 of the platen 38.

In the above-described embodiment, the platen unit 24 is automatically moved from the medium loading position 31 to the print position by the conveying belt 78. Therefore, the time since the T-shirt 100 has been loaded on the platen 38 and until the printing is performed on the T-shirt 100 is short.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art.

Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the above-described embodiment, although the left edge 38B of the platen 38 extends in the front-rear direction parallel to the right edge 38A of the platen 38, the left edge 38B may extend in a direction crossing the front-rear direction.

In the above-described embodiment, although the right handling device 151 has the second electric cylinder 73 and the second pushing bar 74, the second electric cylinder 73 and the second pushing bar 74 may be omitted. In this case, the second right sleeve pushing process is omitted. The first pushing bar 72 may be brought into contact with the center of the up-down direction of the right sleeve 100C in the first right sleeve pushing process, thereby pushing the right sleeve 100C into the under-platen space 46 of the platen 38.

In the above-described embodiment, although the left handling device 152 has the fourth electric cylinder 83 and the fourth pushing bar 84, the fourth electric cylinder 83 and the fourth pushing bar 84 may be omitted. In this case, the second left sleeve pushing process is omitted. The second pushing bar 74 may be brought into contact with the center of the up-down direction of the left sleeve 100D in the first left sleeve pushing process, thereby pushing the left sleeve 100D into the under-platen space 46 of the platen 38.

In the above-described embodiment, although the front handling device 153 has the sixth electric cylinder 93 and the sixth pushing bar 94, the sixth electric cylinder 93 and the sixth pushing bar 94 may be omitted. In this case, the second neckline pushing process is omitted. The fifth pushing bar 92 may be brought into contact with the center of the up-down direction of the collar 100E in the first neckline pushing process, thereby pushing the collar 100E into the under-platen space 46 of the platen 38.

In the above-described embodiment, although each of the first pushing bar 72 and the second pushing bar 74 has the cylindrical shape, the present disclosure is not limited to this, as long as the right sleeve 100C can be pushed into the under-platen space 46 of the platen 38. For example, each of the first pushing bar 72 and the second pushing bar 74 may have an angular prismatic shape or a spherical shape.

In the above-described embodiment, although each of the third pushing bar 82 and the fourth pushing bar 84 has the cylindrical shape, the present disclosure is not limited to this, as long as the left sleeve 100D can be pushed into the under-platen space 46 of the platen 38. For example, each of the third pushing bar 82 and the fourth pushing bar 84 may have an angular prismatic shape or a spherical shape.

In the above-described embodiment, although each of the fifth pushing bar 92 and the sixth pushing bar 94 has the cylindrical shape, the present disclosure is not limited to this, as long as the collar 100E can be pushed into the under-platen space 46 of the platen 38. For example, each of the fifth pushing bar 92 and the sixth pushing bar 94 may have an angular prismatic shape or a spherical shape.

In the above-described embodiment, although the first pushing bar 72 and the second pushing bar 74 are longer in the front-rear direction than the right edge 38A of the platen 38, the first pushing bar 72 and the second pushing bar 74 may be shorter in the front-rear direction than the right edge 38A of the platen 38.

In the above-described embodiment, although the third pushing bar 82 and the fourth pushing bar 84 are longer in the front-rear direction than the left edge 38B of the platen 38, the third pushing bar 82 and the fourth pushing bar 84 may be shorter in the front-rear direction than the left edge 38B of the platen 38.

In the above-described embodiment, although the fifth pushing bar 92 and the sixth pushing bar 94 are longer in the left-right direction than the front edge 38C of the platen 38, the fifth pushing bar 92 and the sixth pushing bar 94 may be shorter in the left-right direction than the front edge 38C of the platen 38.

In the above-described embodiment, although the first left sleeve pushing process is executed concurrently with the first right sleeve pushing process, the first left sleeve pushing process does not need to be executed concurrently with the first right sleeve pushing process. For example, the first left sleeve pushing process may be executed after the second right sleeve pushing process.

In the above-described embodiment, although the pre-treatment device 22 is included in the printing system 1, the pre-treatment device 22 may be omitted. In this case, in step S11, the controller 130 drives the belt motor 77 by a previously set amount, thereby executing a moving process of moving the platen unit 24 from the medium loading position 31 to the print position 33. In this case, the processes in steps S12 to S14 are omitted.

In the above-described embodiment, although the handling apparatus 26 is configured separately from the platen unit 24, the handling apparatus 26 may be configured integrally with the platen unit 24. In this case, the handling apparatus 26 and the platen unit 24 may be disposed integrally, for example, by being fixed to the upper surface of a support plate which extends in the front-rear and left-right directions. The support plate is placed on the placement surface 78A of the conveying belt 78. The handling apparatus 26 and the platen unit 24 are moved integrally by the conveying belt 78 between the medium loading position 31 and the print position 33 in the front-rear direction. Note that at least one of the right handling device 151, the left handling device 152, or the front handling device 153 may be configured integrally with the platen unit 24.

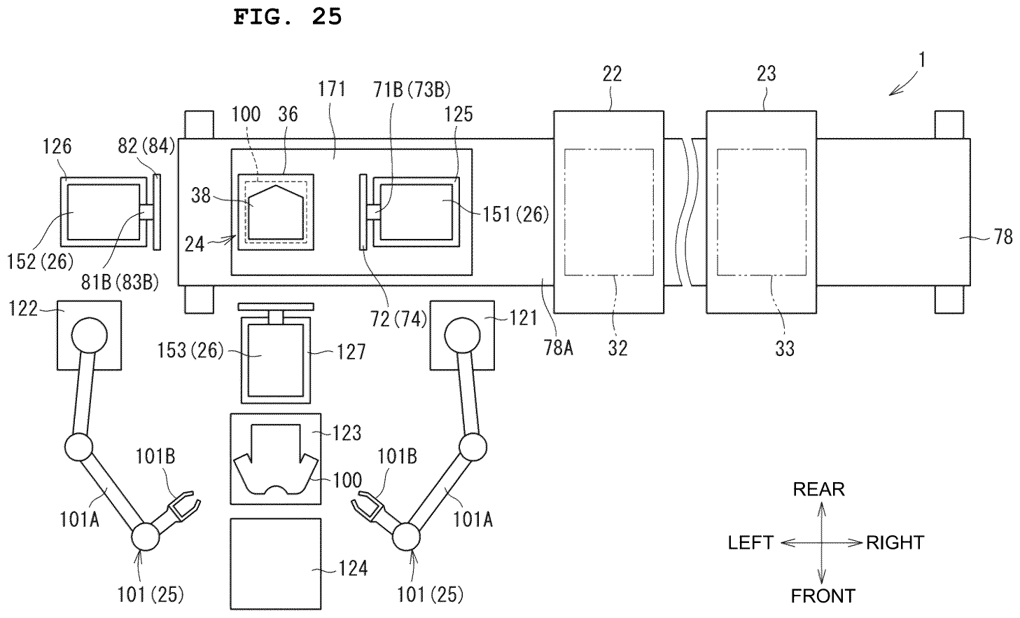

In the above-described embodiment, the platen unit 24 placed on the placement surface 78A of the conveying belt 78 is moved in the front-rear direction by the conveying belt 78. In a modification, however, the platen unit 24 placed on the placement surface 78A of the conveying belt 78 may be moved in the left-right direction by the conveying belt 78, as depicted in FIG. 25. In this case, the handling apparatus 26 is configured integrally with the platen unit 24 in order to avoid collision with the platen unit 24 in a case where the platen unit 24 is moved in the left-right direction by the conveying belt 78. The handling apparatus 26 and the platen unit 24 in this modification are an example of the handling unit. For example, the handling apparatus 26 and the platen unit 24 may be configured integrally by being fixed to the upper surface of a support plate 171 which extends in the front-rear and left-right directions. The support plate 171 is placed on the placement surface 78A of the conveying belt 78. The handling apparatus 26 and the platen unit 24 are integrally moved in the left-right direction between the medium loading position 31 and the print position 33 by the conveying belt 78.

Note that, as depicted in FIG. 25, in a case where the medium loading position 31 is located at a left end part of the conveying belt 78, the right handling device 151 may be singly configured integrally with the platen unit 24. In a case where the medium loading position 31 is located at a right end part of the conveying belt 78, the left handling device 152 may be singly configured integrally with the platen unit 24.

In the above-described embodiment, the handling apparatus 26 has the right handling device 151, the left handling device 152, and the front handling device 153. However, the left handling device 152 and the front handling device 153 may be omitted. In this case, the right handling device 151 may execute, for example, the first right sleeve pushing process, the second right sleeve pushing process, the first left sleeve pushing process, the second left sleeve pushing process, the first neckline pushing process, and the second neckline pushing process in this order. Specifically, the right handling device 151 is fixed to a rotary plate which rotates about a rotation axis extending in the up-down direction. In a case where the right handling device 151 executes the first left sleeve pushing process and the second left sleeve pushing process, the right handling device 151 is located to the right of the platen unit 24. In a case where the right handling device 151 executes the first left sleeve pushing process and the second left sleeve pushing process, the rotary plate rotates to thereby move the right handling device 151 to the left of the platen unit 24. In a case where the right handling device 151 executes the first neckline pushing process and the second neckline pushing process, the rotary plate rotates to thereby move the right handling device 151 to move to the front of the platen unit 24.

In the above-described embodiment, the handling apparatus 26 has the right handling device 151, the left handling device 152, and the front handling device 153. However, the left handling device 152 and the front handling device 153 may be omitted. In this case, the right handling device 151 executes, for example, the first right sleeve pushing process and the second right sleeve pushing process in this order. Alternatively, the right handling device 151 and the front handling device 153 may be omitted. In this case, the left handling device 152 executes, for example, the first left sleeve pushing process and the second left sleeve pushing process in this order. Still alternatively, the right handling device 151 and the left handling device 152 may be omitted. In this case, the front handling device 153 executes, for example, the first neckline pushing process and the second neckline pushing process in this order.

The present specification can be appreciated as disclosing the following technical concepts.

### Item 1

The present disclosure relates to a handling apparatus. The handling apparatus handles a medium having a tubular shape and loaded on a platen extending in a first direction and a second direction crossing the first direction viewed from above, so that a first layer of the medium is located on an upper surface of the platen and a second layer of the medium is located in an under-platen space defined under the platen. The handling apparatus includes: a first moving part movable in the second direction between a first proximate position at which the first moving part is proximate to a first edge of the platen extending in the first direction, and a first separated position at which the first moving part is separated farther from the first edge than at the first proximate position; a first contacting part which is fixed to the first moving part, the first contacting part being located in the under-platen space in a case where the first moving part is located at the first proximate position; and a controller. The controller executes a first pushing process of pushing a first extending area of the medium into the under-platen space, the first extending area being located between the first layer and the second layer in the medium and extending in the second direction outward beyond the first edge of the platen, by moving the first moving part from the first separated position to the first proximate position, after the medium has been loaded on the platen, and by bringing the first contacting part into contact with the first extending area.

Even in a case where the first extending area, as a part of the medium loaded on the platen, extends in the second direction outward beyond the first edge of the platen, the first extending area is automatically pushed into the under-platen space by the first contacting part.

By simply moving the first moving part from the first separated position to the first proximate position in the second direction, the first extending area can be pushed into the under-platen space. Accordingly, the first extending area can be pushed into the under-platen space more quickly than in a case where a complex operation is performed by, for example, a robot arm.

### Item 2

The handling apparatus according to Item 1 may further include: a second moving part movable in the second direction between a second proximate position at which the second moving part is proximate to the first edge of the platen, and a second separated position at which the second moving part is separated farther from the first edge than at the second proximate position; and a second contacting part which is fixed to the second moving part at a position below the first contacting part, the second contacting part being located in the under-platen space in a case where the second moving part is located at the second proximate position. After the controller has executed the first pushing process, the controller may execute a second pushing process of pushing the first extending area into the under-platen space by moving the second moving part from the second separated position to the second proximate position and by bringing the second contacting part into contact with the first extending area.

After an upper part of the first extending area is pushed into the under-platen space of the platen by the first contacting part, a lower part of the first extending area is pushed into the under-platen space by the second contacting part. Accordingly, the first extending area is pushed into the under-platen space more reliably.

### Item 3

In the handling apparatus according to Item 2, the first contacting part may have a shape of a bar extending parallel to the first edge of the platen.

Even in a case where the first extending area is long in a direction in which the first edge of the platen extends, the first contacting part is capable of pushing the first extending area into the under-platen space.

### Item 4

In the handling apparatus according to Item 3, the second contacting part may have a shape of a bar extending parallel to the first edge of the platen.

Even in a case where the first extending area is wide in the direction in which the first edge of the platen extends, the second contacting part is capable of pushing the first extending area into the under-platen space.

### Item 5

In the handling apparatus according to Item 4, the first contacting part and the second contacting part may be longer than a length in the first direction of the first edge.

Even in a case where the first extending area is wide in the direction in which the first edge extends, the first and second contacting parts are capable of pushing the first extending area into the under-platen space more reliably.

### Item 6

In the handling apparatus according to Item 2, the first movement part may be a first electric cylinder having: a first rod extending in the second direction, the first contacting part being fixed to an end in the second direction of the first rod; a first motor; and a first converting mechanism which converts rotational motion of a first shaft of the first motor into linear motion in the second direction of the first rod.

Since the single first motor moves the first moving part in the second direction between the first separated position and the first proximate position, the first pushing process can be executed more quickly than in a case where a robot arm which is operated by a plurality of motors pushes, the first extending area into the under-platen space.

### Item 7

In the handling apparatus according to Item 6, the second movement part may be a second electric cylinder having: a second rod extending in the second direction, the second contacting part being fixed to an end in the second direction of the second rod; a second motor; and a second converting mechanism which converts rotational motion of a second shaft of the second motor into linear motion in the second direction of the second rod.

The single second motor moves the second moving part in the second direction between the second separated position and the second proximate position. Accordingly, the second pushing process can be executed more quickly than in a case where a robot arm which is operated by a plurality of motors pushes the first extending area into the under-platen space.

### Item 8

In the handling apparatus according to Item 2, the first extending area may be a sleeve of a garment. The first contacting part may be brought into contact with the sleeve in the first pushing process.

Even in a case where the sleeve of the garment loaded on the platen extends in the second direction outward beyond the first edge of the platen, the first contacting part is capable of pushing the sleeve into the under-platen space.

### Item 9

In the handling apparatus according to Item 8, the second contacting part may be brought into contact with the sleeve in the second pushing process.

The second contacting part is capable of pushing the sleeve into the under-platen space.

### Item 10

The handling apparatus according to Item 2 may further include: a third moving part movable in the second direction between a third proximate position at which the third moving part is proximate to a second edge of the platen, the second edge extending in the first direction on a side opposite in the second direction to the first edge of the platen, and a third separated position at which the third moving part is separated farther from the second edge than at the third proximate position; and a third contacting part which is fixed to the third moving part, the third contacting part being located in the under-platen space in a case where the third moving part is located at the third proximate position. The controller may execute a third pushing process of pushing a second extending area of the medium into the under-platen space, the second extending area being located between the first layer and the second layer of the medium and extending in the second direction outward beyond the second edge of the platen, by moving the third moving part in the second direction from the third separated position to the third proximate position, concurrently with the first pushing process, and by bringing the third contacting part into contact with the second extending area.

As the first extending area and the second extending area, for example, both sleeves of a garment loaded on the platen can be pushed into the under-platen space concurrently.

### Item 11

The handling apparatus according to Item 10 may further include: a fourth moving part movable in the second direction between a fourth proximate position at which the fourth moving part is proximate to the second edge of the platen and a fourth separated position at which the fourth moving part is separated farther from the second edge than at the fourth proximate position; and a fourth contacting part which is fixed to the fourth moving part at a position below the third contacting part, the fourth contacting part being located in the under-platen space in a case where the fourth moving part is located at the fourth proximate position. After the controller has executed the third pushing process, the controller may execute a fourth pushing process of pushing the second extending area into the under-platen space by moving the fourth moving part from the fourth separated position to the fourth proximate position and by bringing the fourth contacting part into contact with the second extending area.

After an upper part of the second extending area has been pushed into the under-platen space by the third contacting part, a lower part of the second extending area is pushed into the under-platen space by the fourth contacting part. Accordingly, the second extending area can be pushed into the under-platen space more reliably.

### Item 12

The handling apparatus according to Item 11 may further include: a fifth moving part movable in the first direction between a fifth proximate position at which the fifth moving part is proximate to a third edge of the platen, the third edge connecting the first edge and the second edge of the platen and extending in the second direction, and a fifth separated position at which the fifth moving part is separated farther from the third edge than at the fifth proximate position; and a fifth contacting part which is fixed to the fifth moving part, the fifth contacting part being located in the under-platen space in a case where the fifth moving part is located at the fifth proximate position. After the controller has executed the fourth pushing process, the controller may execute a fifth pushing process of pushing a third extending area of the medium into the under-platen space, the third extending area being located between the first layer and the second layer in the medium and extending in the first direction outward beyond the third edge of the platen, by moving the fifth moving part in the first direction from the fifth separated position to the fifth proximate position and by bringing the fifth contacting part into contact with the third extending area.

After the first and second extending areas have been pushed into the under-platen space, the third extending area can be pushed into the under-platen space.

### Item 13

The handling apparatus according to Item 12 may further include: a sixth moving part movable in the first direction between a sixth proximate position at which the sixth moving part is proximate to the third edge of the platen and a sixth separated position at which the sixth moving part is separated farther from the third edge than at the sixth proximate position; and a sixth contacting part which is fixed to the sixth moving part at a position below the fifth contacting part, the sixth contacting part being located in the under-platen space in a case where the sixth moving part is located at the sixth proximate position. After the controller has executed the fifth pushing process, the controller may execute a sixth pushing process of pushing the third extending area into the under-platen space by moving the sixth moving part in the first direction from the sixth separated position to the sixth proximate position and by bringing the sixth contacting part into contact with the third extending area.

After an upper part of the third extending area has been pushed into the under-platen space by the fifth contacting part, a lower part of the third extending area is pushed into the under-platen space by the sixth contacting part. Accordingly, the third extending area can be pushed into the under-platen space more reliably.

### Item 14

In the handling apparatus according to Item 13, the third extending area may be a collar of a garment. The fifth contacting part may be brought into contact with the collar in the fifth pushing process.

Even in a case where the collar of the garment loaded on the platen extends in the first direction outward beyond the third edge of the platen, the fifth contacting part is capable of pushing the collar into the under-platen space.

### Item 15

In the handling apparatus according to Item 14, the sixth contacting part may be brought into contact with the collar in the sixth pushing process.

The sixth contacting part is capable of pushing the collar into the under-platen space.

### Item 16

The present disclosure relates to a handling unit. The handling unit includes: the handling apparatus as defined in any one of Items 1 to 15; and the platen.

Even in a case where the first extending area, as the part of the medium loaded on the platen, extends in the second direction outward beyond the first edge of the platen, the first extending area is automatically pushed into the under-platen space by the first contacting part.

By simply moving the first moving part from the first separated position to the first proximate position in the second direction, the first extending area can be pushed into the under-platen space. Accordingly, the first extending area can be pushed into the under-platen space more quickly than in a case where a complex operation is performed by, for example, a robot arm.

### Item 17

The handling unit according to Item 16 may further include a platen moving part which moves the platen in the first direction. After the controller has executed the first pushing process, the controller may cause the platen moving part to execute a moving process of moving the platen from a medium loading position at which the first pushing process has been executed to a print position at which printing is to be performed on the medium.

Since the platen is automatically moved from the medium loading position to the print position, a time since the medium has been loaded on the platen and until printing is performed on the medium can be shortened.

### Item 18

The handling unit according to Item 16 may further include a platen moving part which moves the platen in the second direction. After the controller has executed the first pushing process, the controller may cause the platen moving part to execute a moving process of moving the platen from a medium loading position at which the first pushing process has been executed to a print position at which printing is to be performed on the medium.

Since the platen is automatically moved from the medium loading position to the print position, a time since the medium has been loaded on the platen and until printing is performed on the medium can be shortened.

### Item 19

In the handling unit according to Item 17 or 18, the platen moving part may integrally move the platen and the handling apparatus.

In a case where the platen is moved from the medium loading position to the print position, the platen does not contact the handling apparatus. Accordingly, the platen can be easily moved by the platen moving part in the first direction or the second direction.

### Item 20

The present disclosure relates to a printing system. The printing system includes: the handling unit as defined in any one of Items 16 to 19; and an ink-jet head which ejects ink to a medium loaded on the platen.

Even in a case where the first extending area, as the part of the medium loaded on the platen, extends in the second direction outward beyond the first edge of the platen, the first extending area is automatically pushed into the under-platen space by the first contacting part.

By simply moving the first moving part from the first separated position to the first proximate position in the second direction, the first extending area can be pushed into the under-platen space. Accordingly, the first extending area can be pushed into the under-platen space more quickly than in a case where a complex operation is performed by, for example, a robot arm.

Further, even in a case where ink mist is generated by ink ejected from the ink-jet head, the ink mist is less likely to adhere to a non-print area of the medium.

### Item 21

The printing system according to Item 20 may further include a platen moving part which moves the platen in the first direction. After the controller has executed the first pushing process, the controller may cause the platen moving part to execute a moving process of moving the platen from a medium loading position at which the first pushing process has been executed to a print position at which printing is to be performed using the ink ejected from the ink-jet head to the medium.

Since the platen is automatically moved from the medium loading position to the print position, the time since the medium has been loaded on the platen and until printing is performed on the medium can be shortened.

### Item 22

The printing system according to Item 20 may further include a platen moving part which moves the platen in the second direction. After the controller has executed the first pushing process, the controller may cause the platen moving part to execute a moving process of moving the platen from a medium loading position at which the first pushing process has been executed to a print position at which printing is to be performed on the medium.

Since the platen is automatically moved from the medium loading position to the print position, the time since the medium has been loaded on the platen and until printing is performed on the medium can be shortened.

### Item 23

In the printing system according to Item 21 or 22, the platen moving part may integrally move the platen and the handling apparatus.

In a case where the platen is moved from the medium loading position to the print position, the platen does not contact the handling apparatus. Accordingly, the platen can be easily moved by the platen moving part in the first direction or the second direction.

What is claimed is

1. A handling apparatus for handling a medium having a tubular shape and loaded on a platen, the platen extending in a first direction and a second direction crossing the first direction, the medium having a first layer located on an upper surface of the platen and a second layer located in an under-platen space defined under the platen in a case where the medium is loaded on a platen, the handling apparatus comprising:
a first moving part configured to move in the second direction between a first proximate position at which the first moving part is proximate to a first edge of the platen extending in the first direction, and a first separated position at which the first moving part is separated farther from the first edge than at the first proximate position;
a first contacting part fixed to the first moving part, the first contacting part being located in the under-platen space in a case where the first moving part is located at the first proximate position; and
a controller, wherein
the controller is configured to execute a first pushing process of pushing a first extending area of the medium into the under-platen space, the first extending area being located between the first layer and the second layer of the medium and extending in the second direction outward beyond the first edge of the platen, and
in the first pushing process, the controller executes:
causing the first moving part to move in the second direction from the first separated position to the first proximate position, after the medium has been loaded on the platen; and
bringing the first contacting part into contact with the first extending area.

2. The handling apparatus according to claim 1, further comprising:
a second moving part configured to move in the second direction between a second proximate position at which the second moving part is proximate to the first edge of the platen, and a second separated position at which the second moving part is separated farther from the first edge than at the second proximate position; and
a second contacting part fixed to the second moving part at a position below the first contacting part, the second contacting part being located in the under-platen space in a case where the second moving part is located at the second proximate position, wherein
the controller is configured to execute a second pushing process of pushing the first extending area into the under-platen space, and
in the second pushing process, the controller executes:
causing the second moving part to move in the second direction from the second separated position to the second proximate position after the controller has executed the first pushing process; and
bringing the second contacting part into contact with the first extending area.

3. The handling apparatus according to claim 2, wherein
the first contacting part has a shape of a bar extending parallel to the first edge of the platen.

4. The handling apparatus according to claim 3, wherein
the second contacting part has a shape of a bar extending parallel to the first edge of the platen.

5. The handling apparatus according to claim 4, wherein
the first contacting part and the second contacting part are longer than a length in the first direction of the first edge.

6. The handling apparatus according to claim 2, wherein
the first movement part is a first electric cylinder having:
a first rod extending in the second direction, the first contacting part being fixed to an end in the second direction of the first rod;
a first motor; and,
a first converting mechanism configured to convert rotational motion of a first shaft of the first motor into linear motion in the second direction of the first rod.

7. The handling apparatus according to claim 6, wherein
the second movement part is a second electric cylinder having:
a second rod extending in the second direction, the second contacting part being fixed to an end in the second direction of the second rod;
a second motor; and
a second converting mechanism configured to convert rotational motion of a second shaft of the second motor into linear motion in the second direction of the second rod.

8. The handling apparatus according to claim 2, wherein
the first extending area is a sleeve of a garment, and
the first contacting part is configured to be brought into contact with the sleeve in the first pushing process.

9. The handling apparatus according to claim 8, wherein
the second contacting part is configured to be brought into contact with the sleeve in the second pushing process.

10. The handling apparatus according to claim 2, further comprising:
a third moving part configured to move in the second direction between a third proximate position at which the third moving part is proximate to a second edge of the platen, the second edge extending in the first direction on a side opposite in the second direction to the first edge of the platen, and a third separated position at which the third moving part is separated farther from the second edge than at the third proximate position; and
a third contacting part which is fixed to the third moving part, the third contacting part being located in the under-platen space in a case where the third moving part is located at the third proximate position, wherein the controller is configured to execute a third pushing process of pushing a second extending area of the medium into the under-platen space, the second extending area being located between the first layer and the second layer of the medium and extending in the second direction outward beyond the second edge of the platen, and
in the third pushing process, the controller executes:
causing the third moving part to move in the second direction from the third separated position to the third proximate position, concurrently with the first pushing process; and
bringing the third contacting part into contact with the second extending area.

11. The handling apparatus according to claim 10, further comprising:
a fourth moving part configured to move in the second direction between a fourth proximate position at which the fourth moving part is proximate to the second edge of the platen, and a fourth separated position at which the fourth moving part is separated farther from the second edge than at the fourth proximate position; and
a fourth contacting part which is fixed to the fourth moving part at a position below the third contacting part, the fourth contacting part being configured to be located in the under-platen space in a case where the fourth moving part is located at the fourth proximate position, wherein
the controller is configured to execute a fourth pushing process of pushing the second extending area into the under-platen space, and
in the fourth pushing process, the controller executes:
causing the fourth moving part to move in the second direction from the fourth separated position to the fourth proximate position, after the controller has executed the third pushing process; and
bringing the fourth contacting part into contact with the second extending area.

12. The handling apparatus according to claim 11, further comprising:
a fifth moving part configured to move in the first direction between a fifth proximate position at which the fifth moving part is proximate to a third edge of the platen, the third edge connecting the first edge and the second edge of the platen and extending in the second direction, and a fifth separated position at which the fifth moving part is separated farther from the third edge than at the fifth proximate position; and
a fifth contacting part which is fixed to the fifth moving part, the fifth contacting part being configured to be located in the under-platen space in a case where the fifth moving part is located at the fifth proximate position, wherein
the controller is configured to execute a fifth pushing process of pushing a third extending area of the medium into the under-platen space, the third extending area being located between the first layer and the second layer of the medium and extending in the first direction outward beyond the third edge of the platen, and
in the fifth pushing process, the controller executes:
causing the fifth moving part to move in the first direction from the fifth separated position to the fifth proximate position, after the controller has executed the fourth pushing process; and
bringing the fifth contacting part into contact with the third extending area.

13. The handling apparatus according to claim 12, further comprising:
a sixth moving part configured to move in the first direction between a sixth proximate position at which the sixth moving part is proximate to the third edge of the platen, and a sixth separated position at which the sixth moving part is separated farther from the third edge than at the sixth proximate position; and
a sixth contacting part which is fixed to the sixth moving part at a position below the fifth contacting part, the sixth contacting part being configured to located in the under-platen space in a case where the sixth moving part is located at the sixth proximate position, wherein
the controller is configured to execute a sixth pushing process of pushing the third extending area into the under-platen space; and
in the sixth pushing process, the controller executes:
causing the sixth moving part to move in the first direction from the sixth separated position to the sixth proximate position, after the controller has executed the fifth pushing process; and
bringing the sixth contacting part into contact with the third extending area.

14. The handling apparatus according to claim 13, wherein
the third extending area is a collar of a garment, and
the fifth contacting part is configured to be brought into contact with the collar in the fifth pushing process.

15. The handling apparatus according to claim 14, wherein
the sixth contacting part is configured to be brought into contact with the collar in the sixth pushing process.

16. A handling unit comprising:
the handling apparatus as defined in claim 1; and
the platen.

17. The handling unit according to claim 16, further comprising a platen moving part configured to move the platen in the first direction, wherein
after the controller has executed the first pushing process, the controller is configured to cause the platen moving part to execute a moving process of moving the platen in the first direction from a medium loading position at which the first pushing process has been executed to a print position at which printing is to be performed on the medium.

18. The handling unit according to claim 16, further comprising a platen moving part configured to move the platen in the second direction, wherein
after the controller has executed the first pushing process, the controller is configured to cause the platen moving part to execute a moving process of moving the platen in the second direction from a medium loading position at which the first pushing process has been executed to a print position at which printing is to be performed on the medium.

19. The handling unit according to claim 17, wherein
the platen moving part is configured to integrally move the platen and the handling apparatus.

20. A printing system comprising:
the handling unit as defined in claim 16; and
an ink-jet head configured to eject ink to a medium loaded on the platen.

21. The printing system according to claim 20, further comprising a platen moving part configured to move the platen in the first direction, wherein
after the controller has executed the first pushing process, the controller is configured to cause the platen moving part to execute a moving process of moving the platen in the first direction from a medium loading position at which the first pushing process has been executed to a print position at which printing is to be performed using the ink ejected from the ink-jet head to the medium.

22. The printing system according to claim 20, further comprising a platen moving part configured to move the platen in the second direction, wherein
after the controller has executed the first pushing process, the controller is configured to cause the platen moving part to execute a moving process of moving the platen in the second direction from a medium loading position at which the first pushing process has been executed to a print position at which printing is to be performed on the medium.

23. The printing system as defined in claim 21, wherein
the platen moving part is configured to integrally move the platen and the handling apparatus.
